(19) United States
(12) Patent Application Publication
(10) Pub. No.: US 2017/0105265 A1
(43) Pub. Date: Apr. 13, 2017

(54) Lighting Systems

(71) Applicant: Laurence P. Sadwick, Salt Lake City, UT (US)

(72) Inventor: Laurence P. Sadwick, Salt Lake City, UT (US)

(21) Appl. No.: 15/314,321

(22) PCT Filed: May 27, 2015
(86) PCT No.: PCT/US2015/032763

§ 371 Date: Nov. 28, 2016

Related U.S. Application Data
(62) Division of application No. 62/003,362, filed on May 27, 2014.

(51) Int. Cl. H05B 37/02; H05B 33/08; F21K 9/232; F21K 9/278; F21K 9/238

(52) U.S. Cl. CPC H05B 37/0227; H05B 37/0281; F21K 9/278; F21K 9/238; F21K 9/232; H05B 33/0845; H05B 33/0896; H05B 33/0857; F21Y 2115/10

(57) ABSTRACT

A lighting system includes at least one solid state light source having a controllable color output, a power supply configured to power the at least one solid state light source, and a controller configured to control the power supply to adjust the color output of the at least one solid state light source and to dim the at least one solid state light source based at least in part on circadian rhythm information.

### BACKGROUND

Fluorescent lamps are widely used in a variety of applications, such as for general purpose lighting in commercial and residential locations, in backlights for liquid crystal displays in computers and televisions, etc. Conventional fluorescent tubes used for general lighting cannot, in general, be directly plugged into alternating current (AC) voltage lines. Fluorescent lamps generally include a glass tube, circle, spiral, ‘U-shaped’ or other shaped bulb containing a gas at low pressure, such as argon, xenon, neon, or krypton, along with low pressure mercury vapor. A fluorescent coating is deposited on the inside of the lamp. As an electrical current is passed through the lamp, mercury atoms are excited and photons are released, most having frequencies in the ultraviolet spectrum. These photons are absorbed by the fluorescent coating, causing it to emit light at visible frequencies.

Electronic ballasts convert the input AC voltage supplied (typically at a low AC frequency of 50 or 60 Hz) power into generally a sinusoidal AC output waveform typically designed for a constant current output in the frequency range of above 20 to 40 kHz to typically less than 100 kHz and sometimes greater than 100 kHz.

Fluorescent lamps can suffer from a number of disadvantages, such as a relatively short life span, flickering, and noisy ballasts, etc.

### SUMMARY

Various embodiments of the present invention provide solid state lighting systems that can be used to replace fluorescent lamps in existing fluorescent lighting fixtures, either with the ballast in place or removed. The present invention also relates to lighting systems with controllable color and/or illumination levels to provide appropriate wavelength lighting at appropriate times as determined by, for example, time of day or night, timing, environment, purpose, use, need, etc.

The embodiments shown and discussed are intended to be examples of the present invention and in no way or form should these examples be viewed as being limiting of and for the present invention.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. Additional embodiments are disclosed in the following detailed description, the appended claims and the accompanying drawings.

### BRIEF DESCRIPTION OF THE FIGURES

A further understanding of the various embodiments of the present invention may be realized by reference to the Figures which are described in remaining portions of the specification. In the Figures, like reference numerals may be used throughout several drawings to refer to similar components.

FIG. 1 depicts a block diagram of a lighting system including a controller and monitor and multiple solid state lighting drivers and sensors in accordance with some embodiments of the invention.

FIG. 2 depicts an in-socket solid state lighting-compatible controller/dimmer in accordance with some embodiments of the invention.

FIG. 3 depicts an in-socket solid state lighting-compatible controller/dimmer and solid state light in accordance with some embodiments of the invention.

FIG. 4 depicts a solid state light mounted in an in-socket solid state lighting-compatible controller/dimmer in accordance with some embodiments of the invention.

FIG. 5 depicts a block diagram of a lighting system including a wireless controller and monitor and sensors in accordance with some embodiments of the invention.

FIG. 6 depicts a block diagram of a lighting system including a wireless controller and monitor and multiple solid state fluorescent light replacements in accordance with some embodiments of the invention.

FIGS. 7-22 depict various embodiments of lighting systems with multiple light emitting panels in accordance with some embodiments of the invention.

FIGS. 23-28 depict various embodiments of an articulating desk lamp with one or more solid state lighting panels in accordance with some embodiments of the invention.

FIG. 29 depicts a block diagram of a lighting system with a wearable monitor in accordance with some embodiments of the invention.

FIGS. 30-31 depict various embodiments of a lighting system with a wearable monitor and a wireless control interface in accordance with some embodiments of the invention.

FIG. 32 depicts a schematic of a power connection circuit for a solid state fluorescent replacement in accordance with some embodiments of the invention.

FIG. 33 depicts a schematic of a startup sequence circuit for a solid state fluorescent replacement in accordance with some embodiments of the invention.

FIG. 34 depicts a schematic of a startup power detection circuit for a solid state fluorescent replacement in accordance with some embodiments of the invention.

FIG. 35 depicts a schematic of a ballast control circuit for a solid state fluorescent replacement in accordance with some embodiments of the invention.

FIG. 36 depicts a schematic of a ballast overvoltage/overcurrent protection circuit for a solid state fluorescent replacement in accordance with some embodiments of the invention.

FIG. 37 depicts the back side of an OLED equivalent array lighting panel in accordance with some embodiments of the invention.

FIG. 38 depicts the front side of an OLED equivalent array lighting panel in accordance with some embodiments of the invention.

FIG. 39 depicts a cross-sectional side view of an array of point light sources in an OLED equivalent array lighting panel in accordance with some embodiments of the invention.

FIG. 40 depicts a solid state lighting fluorescent tube replacement with a single strip of solid state light sources and a cover lens in accordance with some embodiments of the invention.

FIG. 41 depicts a solid state lighting fluorescent tube replacement with a single strip of solid state light sources and circuit and/or sensor elements in accordance with some embodiments of the invention.

FIG. 42 depicts a solid state lighting fluorescent tube replacement with a double strip of solid state light sources in accordance with some embodiments of the invention.

FIG. 43 depicts a solid state lighting fluorescent tube replacement with a double strip of solid state light sources and a cover lens in accordance with some embodiments of the invention.

FIG. 44 depicts a perspective end view of a solid state lighting fluorescent tube replacement with a double strip of solid state light sources and a cover lens in accordance with some embodiments of the invention.

FIG. 45 depicts a solid state lighting fluorescent tube replacement with a double strip of solid state light sources in accordance with some embodiments of the invention.

FIG. 46 depicts a solid state lighting fluorescent tube replacement with a triple strip of solid state light sources and a cover lens in accordance with some embodiments of the invention.

### DETAILED DESCRIPTION OF THE INVENTION

The present invention relates to solid state lighting systems that can be used to replace fluorescent lamps in existing fluorescent lighting fixtures, either with the ballast in place or removed. Embodiments of the present invention also allows either direct ballast or direct alternating current (AC) power to be applied. The present invention also relates to lighting systems with controllable color and/or illumination levels to provide appropriate wavelength lighting at appropriate times as determined by, for example, time of day or night, timing, environment, purpose, use, need, etc.

The present invention can, for example, use shorter (i.e., blue) wavelength light to stimulate and awaken or support waking and healthy state functionality and use longer (i.e., yellow, amber, red, etc.) wavelength light to promote sleep and rest state. For example, amber light emitting diodes (LEDs) and/or organic light emitting diodes (OLEDs) can be used for sleep and blue LED(s) or OLED(s) or other sources of light including but not limited to quantum dots (QDs) for waking and to simulate the exposure to natural sunlight. Other colors including but not limited to orange, yellow-orange, yellow, etc. can also be used. The LEDs, OLEDs, QDs, etc. can be separate colors, panels, or integrated, layered, etc. colors on the same panel and can be of any type and construction. Embodiments of the present invention can use external information such as time of day/night, light levels, computers, websites, smart phones, clocks, atomic clocks and other wired and wireless timing information including weather and weather-related information, time of sunrise and/or time of sunset, etc. combinations of these, etc., to determine whether to have amber (or yellow or red, etc.), blue or both turned on. AC power, solar power, batteries, or a combinations of these, etc. can be used to provide power to the OLEDs, LEDs, QDs, other types of SSL, combinations of these, etc. Embodiments of the present invention can use a portable LED, OLED, QD, combinations of these, etc. panel or panels, other types and sizes (from small to very larger and bigger including tiled, stacked, etc.) panels including troffers, task lamps, bed lamps, table lamps, under counter, over counter, vanity, wall, ceiling, sconce, luminaires, sleep detectors, wearable sleep detectors and circadian rhythm detectors, etc. Embodiments of the present invention can be a fluorescent tube replacement of any length and any diameter that contains multiple color light sources with or without a white light source which can be controlled (i.e., turned on, dimmed) in ways to produce shorter visible wavelength containing light for waking up and waking hours and produce longer visible wavelength containing light with the absence of or greatly reduced shorter wavelength content light for sleeping and resting as well as other types of lights including but not limited to A lamps (including E26 and E27 socket lamps), PAR lamps (including PAR30 and PAR38), R lamps (including R30), flood lamps, PL 2 or 4 pin lamps, MR lamps (including MR16), GU lamps (including GU10), low voltage lamps, low voltage magnetic lighting, etc., combinations of these, etc. Embodiments of the present invention can include circuit implementations that are able to receive and ‘read’, for example, ‘atomic clock’ signals that can be used with other information about geographic location. Such time and position information can, for example, be obtained automatically by using, as an example, a global positioning system (GPS)—which also have their own atomic clocks—which can receive the 60 kHz low frequency transmission, for example sent/transmitted in the USA from Colorado—and the same frequency or relatively similar frequencies in other countries and continents. Such time and position information can be used to set the Circadian Rhythm system to the ‘proper’ phase. In some embodiments of the present invention, the ‘proper’ phase can be overridden and set to a different part of the phase, for example, for shift workers who work at night and sleep during the day or part of the day. This could be manually or automatically determined and set based on, for example, the work and sleep schedule of an individual or groups of individuals, along with potentially other information, etc.

Blue OLED(s) and/or LEDs can be used in light therapy or circadian rhythm treatments to be controlled (i.e., turned on, dimmed) based on weather and/or ambient light conditions, for example based on weather reports in overcast, stormy, gloomy, rainy, winter or otherwise dismal weather. The weather or other conditions can also be determined by sensors such as, but not limited to, light, solar, humidity, temperatures, moisture, spectral and/or precipitation sensors, in some cases in combination with weather reports from one or more sources.

The present invention can use edge emitting LED light sources and displays, edge lit LED light sources and displays, waveguide LED sources and displays, etc. The present invention can consist of or include quantum dot light sources including blended light QD light sources that can produce individual or blended light sources to create full spectrum or single wavelength/color light including wavelengths in the ultraviolet and/or infrared or both. The present invention can use computer monitors/displays and TVs, smart phones, Arduino systems. Raspberry Pi systems, tablets, iPads, iPhones, iPods, Android devices including, but not limited to, smart cellular phones and tablets, and other color displays, monitors, personal digital assistants, etc. It can use photosensors, motion sensors, audio sensors, acoustic sensors, ultrasonic, sonar, radio frequency (RF), radar, vibration sensors, mechanical sensors, vocal sensors, voice sensors, motion sensors, other types of audible sensors including other types of audio sensors, and microphones, including standalone microphones or microphones in other devices such as television remotes, cellular telephones, cameras, etc., proximity sensors, radio frequency identification (RFID), cell phone signals, Bluetooth, WiFi, Wimax, Zigbee, Zwave, other infrared, optical, light, electromagnetic, electromagnetic waves, radio frequency (RF) including, but not limited to the frequency spectrum from less than 1 MHz or KHz to greater than 1 THz or 10 s or 100 s of THz, etc., to smart phones, tablets, global positioning systems (GPS), voice activated, voice recognition, sound activation, selective sound activation, temperature activation, humidity action, motion activation, infrared activation, etc. combinations of these, etc.

For example, the present invention can be implemented so that the user can configure and set the hardware and software interface of the circadian rhythm cycle lighting system and/or, for example, the color-changing including white color changing lighting system so as to, for example, but not limited to, individually input, control, program, interact with, monitor, log, etc. the circadian rhythm lighting system. Embodiments of the present invention can include motion detection/proximity detection/RF detection and decide/determine which color(s) of light to produce, in conjunction and coupled with other sensors, detectors, counters, timers, clocks, etc., including for example but not limited to, sound, photo, light, spectrum, voice, detectors and sensors to turn on to maintain the appropriate circadian rhythm cycle regulation, etc. For example, implementations can turn on and set the hall and other lights to blue enhanced light in, for example, the morning, day or afternoon phases of the circadian rhythm cycle and turn on and set the hall or other lights to blue depressed or blue eliminated light in, for example, the evening, night or night time/sleep time phases of the circadian rhythm cycle. In addition the lights/lighting can be dimmed at any point in the cycle that is appropriate or needed especially at nighttime including both automatically and manually. For example, implementations of the present invention can turn on and set the kitchen lights to blue enhanced light at, for example, breakfast or lunch and possibly dinner and turn on and set the hall or other lights to blue depressed or blue eliminated light (i.e., red, amber, orange, yellow, etc.) in, for example, possibly at dinner or for after dinner snacking, etc. Other situations can include, for example, can turn on and set the bedroom lights to blue enhanced light in, for example, the morning, day or afternoon phases of the circadian rhythm cycle and turn on and set the hall or other lights to blue depressed or blue eliminated light in, for example, the evening, night or night time/sleep time phases of the circadian rhythm cycle. For example, embodiments of the present invention can turn on and set the bathroom lights to blue enhanced light in, for example, the morning, day or afternoon phases of the circadian rhythm cycle and turn on and set the hall lights to blue depressed or blue eliminated light in, for example, the evening, night or night time/sleep time phases of the circadian rhythm cycle. Embodiments of the present invention can use red, green, blue, amber, white LEDs, OLEDs, QDs, other colors of LEDs, OLEDs, QDs and white LEDs, OLEDs, QDs, etc., subsets and combinations of these, etc. Embodiments of the present invention can use RGB OLEDs and LEDs and/or QDs and combinations of RGB OLEDs, LEDs, QDs and white LEDs, OLEDs, QDs, etc. for the lighting.

The present invention can be used to provide one or more wavelengths of light that can be set to turn on or off or dim at various times of the day, night, week, month, etc. to aid in growth and to provide a grow light source, for example for indoor residential plants or gardens, greenhouses, indoor horticulture, vertical farming, urban farming in subway stations, other buildings, to make indoor farm space, etc. Such embodiments can implement wavelength tuning using any suitable light source, such as, but not limited to, light emitting panels, arrays of LED's in single or multiple colors, other solid state lights either directly or in combination with filters, phosphors, diffusers, etc.

The present invention can be battery powered and charged by any method including AC battery chargers, AC/DC battery chargers, inverters, converters, solar energy, mechanical energy, energy harvesting or one or more types, combinations of these, car/automobile chargers, etc.

The present invention can be made to be transparent or nearly transparent and mounted on, embedded in, attached to, etc. windows to control, monitor and permit appropriate wavelength light transmission.

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

The present invention can also provide two or more side (multi-side) lighting for example, for a fluorescent light replacement (FLR) where one side contains a solid state light (SSL) that, for example, consists of white color or white colors of one or more color temperatures and another side contains SSL or other lighting of one or more wavelengths such as red, green, blue, amber, white, yellow, etc., combinations of these, subsets of these, etc. The two or more sided lighting can perform different functions—for example, the side that is primarily white or all white light of one or more color temperatures can provide primary lighting whereas the side that has one or more color/wavelengths of light can provide indication of location, status, code level in, for example, a hospital (i.e., code red, code blue, code yellow, etc.), accent lighting, mood lighting, location indication, emergency information and direction, full spectrum lighting, etc. Some embodiments of the present invention can use multi-SSL packages, for example, multi-LED packages that have more than one LED on a package; as an example, a multi-LED package that contains one or more white color temperatures having different kelvin ratings, an amber LED and a blue LED. Such a package can provide different white combinations along with enhanced blue wavelength content to support wake up for circadian rhythm support as well as amber color to support falling asleep and sleep and also for short wake-up periods to get up to, for example, go to the bathroom and then go back to sleep. In addition to the multi-white color with blue and amber, other colors can be included or substituted including, but not limited to yellow, green, red, orange, other whites, additional whites, purple, yellow-orange, etc., combinations of these, more than one of these, etc.

The present invention can work with all types of communications devices including portable communications devices worn by individuals, walkie-talkie, handie-talkie types of devices, etc.

The present device can use combinations of wireless and wired interfaces to control and monitor; for example for a linear or other fluorescent replacement for, for example, but not limited to, T4, T5, T8, T9, T10, T12, PL 4 pin and 2 pin etc., one (or more) of the replacement lamps can be wireless with wired connections from the one (or more) replacement lamp(s) to the other replacement lamps such that the one or more wireless replacement lamps acts as a master receiving and/or transmitting information, data, commands, etc. wirelessly and passing along or receiving information, data, commands, etc. from the other remaining wired slaved units. In other embodiments one or more wired masters may transfer, transmit, or receive, etc. information, data, commands from other wireless equipped fluorescent lamp replacements, etc. of combinations of these. Wireless options include but are not limited to RF, microwave, optical including infrared transmission and receiving using modulated/demodulated signals including but not limited to approximately 30 to 42 kHz signals, etc. for the master/slaves as well as wired with wires to wires connections between the masters and the slaves.

The present invention can also have one or more thermometers, thermostats, temperature controllers, temperature monitors, thermal imagers, etc., combinations of these, etc. that can be wirelessly or wired interfaced controlled, monitored, etc. Such one or more thermometers, thermostats, temperature controllers, temperature monitors, etc., combinations of these, etc. can be connected/interfaced, for example, but not limited to, by Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, UART, SPI, I2C, RS232, RS485. RS422, other RS standards and serial standards, interfaces, protocols, etc. powerline communications, interfaces, protocols, etc. including both ones that work on DC and/or AC. DMX, DALI, 0 to 10 Volt, other voltage ranges including but not limited to 0 to 3 Volt, 0 to 5 Volt, 1 to 8 Volt, etc. as well as web-based, WiFi-based, Bluetooth, ZigBee, ZWaves, etc. of any type, form, implementation, protocol, etc.

In some embodiments of the present invention, the thermometer(s) and/or thermostats may be remotely located. In other embodiments of the present invention, such a temperature sensor or sensors or thermostat or thermostats, thermal imagers, pyrometers, etc. can use wireless or wired units, interfaces, protocols, devices, circuits, systems, etc.

In addition, embodiments of the present invention can use switches that are remotely controlled and monitored to detect the use of power or the absence of power usage, to open or close garage or other doors by locally and/or remotely sending signals to garage door openers including acting as a switch to complete detection circuits, remembering the status of garage door opening or closing, working with other motion sensors, photosensors, etc. horizontal/vertical detectors, inclinometers, gyrometers, goniometers, accelerometers, etc., including by reflecting an optical signal from a surface for example, but not limited to, using a mirror to reflect an optical signal when the door is vertical and such that the optical signal does not reflect back from the door in a vertical state/position, etc., combinations of these, etc. Embodiments of the present invention can both control and monitor the status of the garage or other door and sound alarms, send alerts, flash lights including flashing white lights and/or one or more color/wavelength lights, turn on lights, turn off lights, activate cameras, record video, images, sounds, voices, respond to sounds, noise, movement, include and use microphones, speakers, earphones, headphones, cellular communications, etc., other communications, combinations of these, etc. Such embodiments and implementations can use Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc., relays, switches, transistors of any type and number, etc., combinations of these, etc.

The present invention also allows various types of radio frequency (RF) devices such as, but not limited to, window shades, drapes, diffusers, garage door openers, cable boxes, satellite boxes, etc. to be controlled and monitored by replacing and integrating these functions into implementations of the present invention including being able to synthesize and reproduce the RF signals which are typically in the range of less than 1 kHz to greater than 5 GHz using one or more RF synthesizers including ones based on phase lock loops and other such frequency tunable and adjustable circuits with may also employ frequency multiplication, amplification, modulation, etc., combinations of these, etc., amplitude modulation, phase modulation, pulses, pulse trains, combinations of these, etc.

A global positioning system (GPS) can be included or used in the present invention to track the location and, for example, to also make decisions as to where and when the present invention should do certain things including but not limited to turning on or off, dimming, etc. Such GPS systems can also make use of cellular phone capabilities as well as other wireless devices using for example signal strength and/or triangulation, etc.

Some embodiments of the system can include thermal imagers including but not limited to IR imagers, IR imaging arrays, non-contact temperature measurements including point temperature and array temperature measurements. These and other sensors are powered in some embodiments by power supplies/drivers/controllers in the lighting system. For example, these and other sensors can be powered and controlled by circuits in a fluorescent replacement lighting system, deriving power through the ballast in a fluorescent fixture or directly from an AC line through the fluorescent fixture if the ballast has been removed. Such sensors can be used to identify normal ambient conditions as well as emergency conditions, and can be used to control lighting and other systems as well as to initiate reports via web, internet, email, text, telephone, etc., or to trigger alarms such as sirens, flashing lights of one or more colors, etc. For example, an IR imaging array in a lighting system can detect cold spots in a room such as an open window or door that should be closed to save energy when outside temperature falls, or to detect hot spots such as a fire or overheating or faulty electrical outlet.

Embodiments of the present invention allow for dimming with both ballasts and AC line voltage, as will be discussed in more detail below.

Embodiments of the present invention can have more than one wavelength or color of LEDs and/or SSLs and can include more than one array of LEDs, OLEDs, QDs, etc. that permit color selection, color blending, color tuning, color adjustment, etc. Embodiments of the present invention can include multiple arrays that can be switched on or off or in or out and/or dimmed with either power being supplied by a ballast or the AC line that can be remotely selected, controlled and monitored. All types of ballasts may be used with various embodiments of the present invention including but not limited to instant start, rapid start, program start, programmed start, preheat, and other types and forms of both electronic and magnetic as well as hybrid ballasts. In various embodiments of the present invention, different wavelengths, combinations of colors and phosphors, etc. can be used to obtain desired performance. Embodiments can include one, two, three or more arrays of SSLs, including, but not limited to, side-by-side, 180 degrees from each other, on opposite sides, on multiple sides for example hexagon or octagon, etc. The SSLs including but not limited to LEDs, OLEDs, QDs, etc. may be put in series, parallel or combinations of series and parallel, parallel and series, etc. In other embodiments of the present invention, phosphors, quantum dots, and other types of light absorbing/changing materials that for example can effectively change wavelengths, colors, etc. for example by applying a voltage bias or electric field. The present invention can also take the form of linear fluorescent lamps from less than 1 foot to more than 8 feet in length and may typically be T4, T5, T8, T9, T10, T12, PL 4 pin and 2 pin, etc. Such embodiments of the present invention may use an insulating housing made from, for example but not limited to, glass or an appropriate type of plastic, which may or may not have a diffuser or be a diffuser in terms of the plastic. In some embodiments of the present invention plastic housings may be used that can include diffusers on the entire surface, diffusers on half the surface, diffusers on less than half the surface, diffusers on more than half of the surface, with the rest of the surface either being clear plastic, opaque plastic or a metal such as aluminum or an aluminum alloy.

Photon/wavelength conversion including down conversion can be used with the present invention including being able to adjust the photon/wavelength conversion electrically. Spectral/spectrum sensors can be used to detect the light spectral content and adjust the light spectrum by turning on or off certain wavelengths/colors of SSL. The spectral sensors could consist of color/wavelength sensitive detectors covering a range of colors/wavelengths of filters that only each only permit a certain, typically relatively narrow, range of wavelengths to be detected. As an example, red, orange, amber, yellow, green, blue, purple, etc. color detectors could be included as part of the spectral/spectrum sensor or sensors. In some embodiments of the present invention, quantum dots can be used as part of and to implement the spectral/spectrum sensors.

The present invention can used as a switch to open or close, for example, garage doors and other types of residential, commercial or industrial doors by, for example, sending a signal such as a contact closure to open/raise or close/lower the door or doors or, for example, gates at a parking garage or other types of facilities. Such a signal can be activated using wired, wireless, or powerline approaches including serial, parallel, analog, digital, combinations of these including but not limited to those discussed herein including but not limited to Bluetooth of any type or flavor including Bluetooth, Bluetooth low energy, WiFi, IEEE 801, IEEE 802, ZigBee, Zwave, other 2.4 GHz and related/associated standards, protocols, interfaces, RFID, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc. In addition, voice commands, voice recognition, voice detection, fingerprint, retinal, face, speed, velocity, proximity, direction, time of day, location, whether conditions, weight, height, other features, motion, other characteristics, other forms of detection, etc., other combinations can be used in combination to command the door to open or shut. Optionally, horizontal and vertical detection can be used for example on garage doors, residential, commercial, industrial, etc. doors of any type and form including recreational vehicle (RV) and boat doors, storage facilities, etc. to command, detect, report, alert, alarm, monitor, control, etc. An example embodiment could use for example a Bluetooth controlled switch that can be activated from a cellular phone or tablet which could take in gesture commands, typed commands, voice commands, and other forms of commands to open or close the respective door by activated the switch. This example could also be coupled with detecting the distance of approach or a vehicle, bicycle, car, automobile, person, animal, other types of moving inanimate or animate (or both) objects, etc. combinations of these, etc. For example, as a car approaches a driveway or gate (including but not limited to home gates, parking lot gates, etc.) or both the signal strength of the Bluetooth device (i.e., cell phone, smart phone, tablet, custom remote, generic remote with Bluetooth) can be detected to achieve an appropriate signal strength level to open the gate or garage door or both. As another example, GPS can be used to detect the car or other inanimate or animate moving toward or away from the garage and the present invention can take appropriate action, for example, opening the garage or closing the garage as the car or other inanimate or animate moves toward or away from the garage. In still other example embodiments, voice commands can be used as part of the present invention with either dedicated to this purpose or general usage as part of the overall present invention with specific or distributed microphones, etc. to open or close the door or gate either with or without devices using, depending on the desired level of, for example, security, specific commands or secure commands or voice identification commands.

Such implementations of the present invention can be battery powered, solar powered including with both sunlight and ‘artificial’ light from light sources, battery powered with solar charging including with both sunlight and ‘artificial’ light from light sources, vibration and/or mechanically powered, battery powered with vibration or mechanical charging of the batteries, etc., being powered by the garage door opener, the gate opener, lighting for opener, AC wall power, other sources of power, etc., combinations of these including with both sunlight and ‘artificial’ light from light sources, etc. The switch or switches can take a diverse variety of forms including, but not limited to, electrical, mechanical, electromechanical, semiconductor, transistors of any type, vacuum tubes of any type, relays of any type including coil, reed, solenoid, static, latching, etc. Implementations of the present invention can be put at virtually any location and consist of a black box with no auxiliary user inputs, an on/off switch that is in parallel with the remotely controlled switch or switches, a toggle switch that is in parallel with the remotely controlled switch or switches, a momentary switch that is in parallel with the remotely controlled switch or switches, a keypad switch that is in parallel with the remotely controlled switch or switches, a touch pad switch that is in parallel with the remotely controlled switch or switches, a screen including but not limited to a touchscreen with a switch that is in parallel with the remotely controlled switch or switches, a slider switch(es) that is in parallel with the remotely controlled switch or switches, a capacitive coupled switch or switches switch that is in parallel with the remotely controlled switch or switches, etc., combinations of these, etc. Implementations of the present invention can also include sliding doors, patio doors, French doors, etc., for example controlling lighting based on door usage, door position, light through the door, and for example controlling doors, locking/unlocking doors, reporting position and locked state of doors, etc. Temporary permission for access may also be granted both locally and globally. In addition to opening the door and turning on any lights directly associated with opening the door, implementations of the present invention can also turn on other lights including to a prescribed, sequenced, scheduled, etc. or other level, etc., as well as turn on or off other devices including but not limited to air conditioners, heaters, furnaces, appliances, fans, etc.

Embodiments of the present invention can be used as a smart and secure pet door with the Bluetooth, RFID, WiFi, ISM, and/or other wireless only allowing the pet door to open when the animal wearing such a device is near.

The present invention can also form a Community where such a community can consist of neighbors, friends, family, others, located nearby or in other parts of a state, country, continent, world, etc. who remain in relative contact and collectively remain in contact in general such that using telephone lines, cellular/mobile communications, internet, radio communication, fiber communications, etc., the various embodiments of the present invention can be linked to others in terms of the control, monitoring, sensing, logging, etc. As an example, the SSL or other lighting can be set to flash in a single white color, multiple white colors, multiple colors, red color, or other colors when some potentially dangerous or life-threatening situation happens such as a fire, smoke, an unauthorized entry, intruder, motion detection, movement detection, etc. including both random and systematic, water leakage, natural gas leakage, electricity usage both in general and at specific locations, circuit breakers, junction boxes, outlets, etc., water flow, water usage, the lack of water usage, power outage, excessive power usage, too little power usage, lack of telephone, internet, etc., lack of response from inhabitants of house, a fall or injury, failure to contact one or more individuals or entities, screams, key words, certain words, code words, excessive vibrations, voice commands, over-heated areas, under-heated areas, too low of a temperature, too high of a temperature, thermal detection, thermal scans, abnormalities in the thermal scans or detections, video capture, detection, imaging, or recognition, etc., an appliance or appliances left on too long, an appliance or appliances left on too short of a time or not turned on, combinations of these, etc.—these events may also trigger optional alerts including speaker, siren, voice generation, etc. to be sent out locally as well as via cellular phone networks, internet, web, e-mail, texts, pictures, video, etc., combinations of these, etc. to all or a subset of the Community.

Some embodiments of the present invention include various means to detect sleep, heart rate, pulse rate, blood pressure, sleep state, sleep tracker, activity tracker, oximeter, etc. to control the SSL and other lighting. For example, many of the wearable technologies for sleep tracking, monitoring, adjustment, feedback, etc. as well as heart rate, pulse rate, blood pressure, oximetry, activity, wake or sleep state, general or specific health state, etc., combinations of these, use Bluetooth to communicate and interface to smart phones and tablets, etc. This also applies to many of the non-contact and/or proximity systems. As an example, the present invention can interface, connect, intercept, obtain, etc. the information being transmitted directly or indirectly for example but not limited to using the wearable device, using a phone or tablet app, using a laptop or desktop computer, using a server, using a dedicated interface, etc.

The present invention can also have interfaces which are either built-in or stand alone/separate that accept and translate various control signals, information, etc. that are either one way (i.e., control) or two-way (control and monitor) to various standards and protocol including BACNET, LONNET, and similar HVAC/lighting standards and protocols, etc. In addition, other interfaces such as WiFi to Bluetooth or Bluetooth to WiFi, Wink. WeMo, etc. may also be used in certain embodiments of the present invention.

Embodiments of the present invention can also have isolated outputs that can supply power for other uses including USB uses (i.e., 5 volt), other voltage and current values, switches, relays, etc. to power, drive, signal, etc. Embodiments of the present invention can include batteries as part of the implementation or be powered by back-up batteries, emergency batteries, solar power directly or indirectly (using batteries, fuel cells, etc.), vibration or mechanical energy sources, uninterruptible power supplies (UPSs), emergency power sources, emergency ballasts, etc., combinations of these, etc. and can provide emergency (or other power) to charge or power cell phone(s), tablet(s), radio(s), laptops, computers, other personal device assistants, etc. during an emergency or at other times.

The present invention can be used to aid in circadian rhythm regulation and cycle synchronization as well as Seasonal Affective Disorder (SAD). The present invention can aid in correcting sleep disorders and provide light therapy including for SAD. The present invention can use input, feedback, etc. including human physiological and biological input and feedback and environmental (including, but not limited to, temperature, time of day or night, ambient light, light spectrum, etc.) to control and monitor the light including the colors/wavelengths and/or the intensity of the light, etc.

The present invention can be used for personal or professional use and applications. The present invention can be used, for example, in hospitals, rest homes, senior care homes, rehabilitation facilities, short term and long term care facilities, homes, residences, commercial and industrial buildings and locations, schools including K12, universities, colleges, etc., in cleanrooms, in confined spaces, in spaces devoid of natural light, on ships, buses, boats, planes, aircraft, submarines, vessels, all times of marine, ground, air and space vehicles including transport and working environments, spaces, vehicles, etc.

The present invention can use actimetry, sleep actigraphs which can be of any form including watch-shaped and worn on the wrist of the non-dominant arm, temperature, EEG, wrist, body movements, polysomnography (PSG) and other such techniques, etc.

The present invention can also be used to provide relatively dim illumination at night of appropriate wavelengths and can be integrated into a single light source and sensor unit to provide lighting sufficient for sleeptime/nighttime use and egress for, for example, children and adults including more aged and senior adults and parental or other (including, but not limited to nursing, nurse assistant, care giver, hospital, rest home, hospice, trauma, emergency room and similar environments, recovery, rehabilitation, assisted living, elderly living, senior care, etc. centers/facilities, etc.), dementia of all types and forms, etc., and to provide various types of light therapy including but not limited to individual, customized, programmable, adjustable, adaptable, etc. The present invention lighting can be used for, for example but not limited to, seniors, families, businesses, residences, homes, houses, elderly, physically impaired people and persons, etc. to signal, alarm and/or alert others of an emergency, an intrusion, a fire, a fall, an injury, toxic or explosive gases, loss of heating, water leakage, etc., by for example flashing lights, on-off lights at certain periods of repetition, different colors flashing, different patterns of colors, different intensities and dimming, etc., combinations of these, etc. In some cases, the interior/indoor lights can be set to full on/full brightness while the exterior/outdoor lights can be set to flashing or other modes including but not limited to those discussed herein. In some embodiments audio alarms including but not limited to sirens, recorded or synthesized voice messages, actual sounds from microphones within the house, synthesized ring tones, alarms, alerts, etc., other types of patterns of sound, music, etc., combinations of these, etc. can be used.

The present device can be made into light sources, including but not limited to sheet light sources, which can incorporate solar cells either on the front or the back, and optional energy storage such as batteries to create a light source that can be powered when there is no sunlight or can also act as a privacy screen and/or temperature reducer over windows by absorbing and blocking the sunlight (and potentially associated heat and UV rays) from entering the space on the interior side of the window while still powering and providing energy to the light sources to illuminate the interior space(s).

The present invention can use projectors, television sets, computer monitors and other displays, etc. including as light sources and to provide light of various and different colors including different white light colors including for use in light therapy including but not limited to circadian rhythm, SAD, dementia, other maladies, illnesses, diseases, etc., combinations of these, etc. Implementations of the present invention can include using televisions including older televisions that can be switched on and set to appropriate wavelengths for waking up and appropriate wavelengths for resting/going to sleep, etc. Embodiments of the present invention can use an interface/conversion/communication device/box/unit/etc. that can, for example, use the duplication of the remote control signals to turn on the television and set the channel such that the signals applied to the specifically set channel produce the desired wavelength spectrum. Embodiments of the present invention can also use a remotely controlled switch to turn on the television, projector, etc. Audio signals may also be used and applied to assist in waking or sleeping, such as, but not limited to, synthesized, simulated, emulated, and/or recorded voices, sounds, environments, tones, natural or man-made sounds, live streaming, personal communications, television, radio, other broadcasting whether wireless, web-based, cable, wired, etc., combinations of these, alarm clocks, either alone or in combination with changing light levels and/or wavelengths, in order to provide predetermined, or programmable, randomized, live, etc., audible and/or light-based alarms, whether gradual gentle, insistent, etc. Such alarms can be adapted for slow or fast waking of individuals with a range of light sleeper to deep sleeper characteristics. Changing light patterns in alarms can simulate sunrise or other conditions, etc. or in certain cases, sunset or other times of the day or night. etc. which can be customized and personalized for a person, persons, groups of people, etc.

The present invention can be used to gently or urgently or anything in between wake a person or people by providing light with high/significant or total blue wavelength content. Such implementations of the present invention can be used in one or more locations that are collocated/local or located miles or continents apart. The present invention can control and monitor one or multiple light sources in one or more locations. For example parents can set one or more wake up sequences where the light can, for example, but not limited to, dim up slowly or go to full brightness instantly, provide vocals including, but not limited to, music, horns, buzzer, alarm, synthesized sounds, noise, nature, ocean and other sounds, combinations of sounds, voices, familiar voices, voice generated or previous voice recorded, etc. In a similar fashion, the present invention can include night-time or sleep time to control and monitor one or more light sources and optionally electrical outlets such as, for example, but not limited to, to control the turn off, dimming including gradual or abrupt or anything in between the light sources in one or more locations including the same or different rooms which could be set to simultaneously, separately, staggered, or other scheduling or sequencing of the light and related control. In some embodiments of the present invention, the amplitude of a sound, noise, acoustic, thud, vibration, mechanical, sounds associated with movement can be detected and optionally amplified including remotely amplified using commands, automatic signals, remote control and signals, etc.

Embodiments of the present invention can also use an infrared to RF wireless universal interpreter/converter as described in PCT Patent Application PCT/US15/12965 filed Jan. 26, 2015 for “Solid State Lighting Systems” which is incorporated herein by reference for all purposes. Such a universal interpreter/converter allows control of portable devices such as portable air conditioners, window air conditioners, portable heaters and furnaces, portable space heaters, portable space coolers, etc., entertainment devices, units, systems, etc., humidifiers, etc. In some embodiments of the present invention the infrared to RF wireless universal interpreter/universal converter/adapter may be installed in and included as part of a lamp, bulb, light fixture, etc., may be battery operated with a solar charger, a mechanical energy charger, other types of energy harvesting, etc. Such implementations of the present invention can use one or more mobile, portable wireless devices including, but not limited to, remote temperature sensors, smart phone temperature sensors and measurement devices, integrated circuits, etc., Bluetooth temperature sensors and measurement devices, tablet temperature sensors, etc., humidity sensors and measurement devices, etc. One or more of these sensors in one or more nearby locations may be used, for example, as temperature control points/locations for which certain embodiments of the present invention can be commanded to modify the temperature until one or more of the temperature setpoints are reached and maintained. Some embodiments of the present invention can also monitor the power (i.e., voltage, current, apparent power, real power, power factor, etc.) to monitor, store, calculate, make decisions, provide analytics, etc. of the heating and cooling energy use, etc.

In example embodiments of the present invention a power supply can be included in which the frequency can be detected using a microprocessor, microcontroller, FPGA, DSP, analog circuit, other digital circuits, combinations of these, etc. A switch including, for example, a transistor such as a field effect transistor (FET) such as a MOSFET or JFET can be used in the power supply to, for example, either turn on or turn off a circuit that operates in either ballast mode or AC line mode depending on the amplitude of the signal or with the inclusion of a time constant, the average, RMS. etc. voltage level. The present invention removes the requirement that a reference level and a comparison to the reference level being required to detect the amplitude of the waveform.

Some embodiments of the present invention include a solid state lighting (SSL) replacement which could include but is not limited to a light emitting diode (LED), a organic light emitting diode (OLED), quantum dot (QD), etc. combinations of these, etc., replacement lamp that can be directly put into, for example, but not limited to, 2 ft and 4 ft linear fluorescent tube sockets, tombstones, or other fixtures, other types of fluorescent fixtures and sockets, including but not limited to, PL 2 and 4 pin sockets, fixtures, etc. and receive power directly from electronic ballasts (i.e., instant start, rapid start, programmed start) and also magnetic ballasts or in lieu of the ballast, AC line voltage including being able to accept universal AC line voltage. The LED fluorescent tube replacements (FLRs) have a unique and innovative aspect in that the LED FLRs can be wirelessly dimmed and support both manual and daylight harvesting controls including standard 0 to 10 V, DALI, DMX, and other interoperable protocols and interfaces including, but not limited to, interfaces that support standards including Building Automation Control Network (BACnet) which is an open, standard communication protocol by the American Society of Heating, Refrigerating, and Air-Conditioning Engineers (ASHRAE) and LON (LonTalk), a protocol developed by the Echelon Corporation later named as standard EIA-709.1 by the Electronics Industries Alliance (EIA) that have been established for building automation system (BAS) vendors, manufacturers, suppliers, etc. to enhance and further enable the adoption of LED luminaires and FLRs in building automation.

The present invention uses wireless signals to both control (i.e., dim) the LED FLR and monitor the LED current, voltage and power and can provide analytics, fault reporting, power usage, activation alerts, monitor traffic including the motion and sound and also video from for example a camera powered through the present invention including receiving power from a ballast, and including video and media traffic, digital media traffic, auto traffic. Power from a ballast/AC line can be used to power any devices in the lighting system, such as, but not limited to, security cameras, web cameras, remote monitoring, cameras, surveillance cameras, etc., combinations of these, etc. used to trigger actions rather than generating images, Bluetooth traffic monitors, motion sensing or sound sensors that are ballast powered, light sensors, etc. Optional sensors allow for relative light output to be measured and wirelessly reported, monitored, and logged permitting analytics to be performed. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or Bluetooth including all variants such as, but not limited to, Bluetooth low energy, Bluetooth Mesh, ZigBee, ZWave, IEEE 802, or WiFi. In addition to these types of occupancy/motion sensors, photo sensors and daylight harvesting controls, simple and low cost interfaces that allow existing or other brands, makes, and models of daylight harvesting controls, photo sensors, occupancy/motion/proximity sensors, voice recognition, voice commands, gesturing, face recognition, magnetic sensors, infrared sensors, magnetic key cards, other types of sensors, RFID, cellular phones, smart phones, tablets, laptops, desktops, servers, etc., combinations of these, subsets of these, etc. to be connected to and control/dim and/or change color(s)/wavelength(s), etc. the wireless SSL including but not limited to LED, OLED, and/or QD FLRs in various embodiments of the present invention can be used. In addition, wired and powerline (PLC) interfaces may be used with the present inventions as well as multiple types and forms of local and remote sensors, detectors, transmitters, receivers, responders, etc.

These SSL FLRs are highly efficient especially with energy harvesting. The present invention is applicable to office, retail, food service, hospitality, healthcare, school, military, government buildings, etc. and can include cybersecure communications.

The present invention provides modular solutions and kits some of which can be selected at time of manufacturing, some of which can be added and are field-installable without the need for experience of knowledge of advanced electronics or the details of SSL systems—and all of which are low-cost and can provide additional energy savings. An optional but not necessary component of the control firmware, hardware and software is additional processor capability that can also be easily integrated into SSL systems.

The present invention employs low-cost, adaptive sensors and controls that can often communicate at low data rates with low data content to achieve energy usage reduction for a wide range of lighting products including both SSL and non-SSL products (that can later be replaced with SSL products); in addition this allows for existing dimmable and non-dimmable SSL products to be made more energy efficient. The merits include reduced energy consumption and cost as well as providing enhanced performance and functionality. Enhanced high speed, high data content (including video, video streaming, data mining, data gathering, etc.) versions of the present invention can also be implemented.

The present invention can be highly energy efficient, low-cost to manufacture and price enabling as well as designed to work with numerous platforms, including smart phones (i.e., iPhones, Androids), tablets (i.e., iPods, Androids), computers, Arduinos, Raspberry Pi(s), do-it-yourself (DIY) and novices, both smart and dumb (with a wireless interface) TVs including HDTVs, 4D TVs, TVs that are only NTSC-compatible (and not HDTV-compatible). Implementations of the present invention can be, for example, in both kit forms and fully assembled, tested and ready-to-plug-and-play modules and units. The system, once setup, can be self-maintained or controlled, monitored and data logged (including analytics) using, for example, the industrial, scientific and medical (ISM) radio frequency (RF) bands and/or powerline control (PLC) and/or wired interfaces and connections using low-cost components and electronics or virtually any other method including optional (and not required) interfaces ranging from low-tech to very high-tech. The present invention does not require the internet or internet protocol (IP) addresses to operate; however optional choices and accessories allow internet-connectivity if so desired. The present invention, in some embodiments, can also respond to voice commands and gesturing. Smart phones and tablets can be connected in a number of ways to the present invention innovative SSL energy savings sensor system including, but not limited to, Bluetooth (including Bluetooth Low Energy) and other ways without or with the internet or IPs.

The present invention includes a family of SSL lighting products including innovative, ultra-efficient, highly flexible power supplies and drivers for LEDs, QDs and OLEDs.

The present invention provides power supplies and associated control and monitoring electronics that enable and support rapid introduction of both SSL replacement and innovative general lighting and luminaires for residential, commercial, educational and industrial applications and markets.

In particular these power supplies and drivers for SSL can convert AC input to DC output power, have a high power factor (PF) and low total harmonic distortion (THD), support various types of dimming, meet FCC EMI limits, provide over-current (OCP), over-voltage (OVP), over-temperature (OTP) and short circuit protection (SCP). Of great importance, these power supplies are high to ultrahigh efficient and in some embodiments are amenable to form fit applications for LEDs and OLEDs including edge-emitting LEDs and edge lit LED lighting. Implementations of the present invention include ultra-efficient, highly flexible family of isolated and non-isolated power supplies for SSLs that support both white light and color tunable red/green/blue (RGB) as well as other color combinations including red/green/blue/amber (RGBA) and red/green/blue/amber (RGBA) coupled with one or more white colors (i.e., one or more white color temperatures) modes of SSL operation.

The present invention includes smart, feature-full SSL drivers and photo/light, noise, and/or motion sensors that are very low power and capable of sending information wirelessly (or wired) to one or more controller/monitor units or directly to the SSL power supplies and drivers or combinations of these. The smart drivers, in addition to the performance specified for the simple drivers support, among others, optional wall (Triac), 0 to 10 V, powerline (PLC), wired and wireless dimming. In addition to versions that support white light dimming via ISM RF signals and, optionally (via, for example Bluetooth, Bluetooth Low Energy, Zwave, ZigBee or WiFi), smart phones, tablets, iPods, iPads, iPhones, Android devices, Kindles, computers, etc., RGB or RGBA or other combinations of more or less color/mood changing SSL panels can also be supported via the same interfaces and mobile/computer devices. Unlike simple infrared controlled RGB lightstrips, ropes and the likes with limited color choices and dimming levels, the present invention RGB lighting allows for high resolution 8-bit to 12-bit (256 to 1024) or higher resolution color levels per RGB channel and with innovative ways to interactively and dynamically user-select the resolution and dimming level. The present invention can be self learning and can support artificial intelligence including but not limited to in terms of lighting, light therapy, light growth, light interactions, etc., combinations of these, for, but not limited to, humans, animals, plants, insects, etc.

Solid state lighting, including light emitting diodes (LEDs) and organic light emitting diodes (OLEDs) and quantum dots QDs, has the capabilities to provide significant energy reduction resulting in, among other things, less dependence on foreign sources of energy and less wasted energy including wasted heat energy. SSL provides quality benefits for general lighting in both residential and commercial applications that are not possible using fluorescent lighting or most other types of lighting. Improved visual quality is a result of several intrinsic characteristics of SSL systems. For example, newer types of SSLs have brightness levels that are actually visually pleasing to view directly. Given their unique form coupled with power supplies and drivers specifically optimized to enable and exploit the unique form factors and inherent flexibility and digital nature of SSLs, tremendous design flexibility is an inevitable result, thereby creating the possibility of new and innovative luminaires, lighting design approaches, and architectural integration. SSLs also enable luminaires with superior color attributes. These superior color attributes include user-adjustable and selectable RGB and, for example, but not limited to RGBA color and high ‘white light’ CRI, and even color temperature tunability. SSL luminaires not only eliminate hazardous material but also embed less energy in the manufacturing and transportation processes. The thinness and minimal weight of the SSLs facilitate the use of lighter and innovative materials in the luminaire construction. Integrating energy efficient solid-state lighting with advanced sensors, controls and connectivity provides for a family of comprehensive lighting products including control and monitoring products that further reduce energy usage while enhancing the user-experience.

The present invention includes implementations that are compact, low-cost multipoint addressable RF control and monitoring system that includes SSLs, photo/light sensors, motion sensors, control, dimmers (which can also function and be set to on/off mode) that SSL and other light source types can be plugged or screwed into. The light and motion sensors can, for example, be battery and/or solar powered and only send/transmit information/signals when there is change (i.e., the ambient light changes appreciably compared to a reference set-point, motion is detected or not detected, etc.). Implementations of the present invention can include integrated circuits (ICs) to be used in, for example, but not limited to, SSL drivers, dimmers, and sensors. Such sensors and other circuits in a lighting system can be powered by a ballast in a lighting fixture, or, if the ballast has been removed or otherwise bypassed, directly from the AC line through the lighting fixture. In some embodiments, sensors in the system can recognize occupants based on, for example, but not limited to the Bluetooth fingerprint of their electronic devices as they enter a room, and configure lighting levels, colors wavelengths etc. based on their stored preferences automatically, or based on time of day or week, holidays, financial reports, cost of energy at a given time or day, weather reports, temperature indoors or outdoors, emergency conditions, smoke detectors, etc. The ballast or AC line in the lighting system can be used as a power source for any connected device, such as, but not limited to, including a thermostat in the light fixture, with Bluetooth control, WiFi, or any other interface. The system can include IR temperature sensor or thermal imaging camera(s) to measure ambient temperature or point temperatures in the room or other environment around the light fixture. Such sensors or thermal imaging cameras could measure temperature differentials throughout the room to trigger an alarm if temperature differentials are detected that are greater than a threshold. Such sensors can be moved in some embodiments, for example by mounting on a motorized gimbal. In some embodiments lenses or filters, such as a fisheye lens, can be used in connection with sensors to increase the monitored area. Such sensors can be used to monitor for abnormal temperature differentials, identifying fires, faulty and overheating electrical outlets or wiring, windows or doors needing to be closed, motion or movement, forced entry, etc. The system can include adaptive control such as, but not limited to, artificial intelligence systems to determine normal operating conditions and to identify and signal abnormal conditions. In some embodiments,

The lighting system can be used with high intensity discharge (HID) lights in schools, gyms, hospitals, nursing homes, shopping centers, etc., to provide tunable light colors/wavelengths and illumination levels, both for normal operating conditions and emergency conditions of any types. For example, lighting in a school gym can be controlled during a dance to vary the color and intensity to enhance the atmosphere of the dance, in some cases based on the music. In the event of a fire or other emergency, the light can, for example but not limited to, be switched to flashing red light or a combination of solid white and flashing red light to facilitate exit from the building.

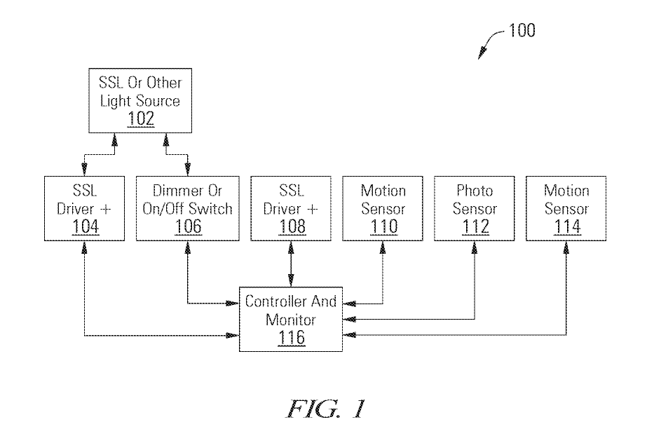

Turning to FIG. 1, a simplified block diagram depicts a lighting system 100 including a controller and monitor 116 and multiple solid state lighting drivers and sensors in accordance with some embodiments of the invention. The lighting system 100 can include any number of SSL drivers (e.g., 104, 108) to power SSL or other light sources (e.g., 102), along with controllers such as, but not limited to, dimmers or controllable on/off switches (e.g., 106). The lighting system 100 can also include and integrate any number of sensors, such as, but not limited to, motion sensors (e.g., 110, 114), photosensors (e.g., 112), thermal imaging cameras or arrays, data connections to receive data such as time and date, occupant schedules, location, weather reports, news information, etc., enabling the controller and monitor 116 to customize lighting control etc. Communication between elements in the lighting system 100 can be one-way or two-way or both. As a non-limiting example in one embodiment, the motion sensor (e.g., 110) might only transmit, the dimmer/on/off switch (e.g., 106) might be receive only to receive to transmissions from the controller and monitor 116 or directly from a respective sensor (e.g., 110). In other embodiments the SSL drivers and dimmers also transmit information to, e.g., the controller.

Some embodiments of the present invention include relatively low-cost ISM and/or Bluetooth transceivers and further reduce cost and power consumption so as to make long-term and longlife operation possible using, for example, small batteries or solar power/charging or both. In some embodiments of the present invention solar or other types of charging including those discussed herein can be used to recharge the battery or batteries using for example but not limited to buck boost, buck, boost, boost buck, flyback, forward converters, half bridges, full bridge, push-pull, Cuk, SEPIC, etc. topologies.

Some embodiments of the present invention support low power operation including deep-sleep ultra-low power mode such that the power consumption is extremely low when not transmitting or receiving, and also optimizing transmit and receive power. In some embodiments, the intent is to send only as much data as needed and not to go ‘overboard’ in terms of information sent and received.

Addressing protocol and firmware/hardware setting and programming can be used to control and monitor the present invention including individually addressing the drivers, dimmers and sensors. One simple approach would be to use physical DIP switches to set the address of each unit. Another approach is to have a low-cost programming station that the user purchases as a one-time-only expense that allows easy user programming of the drivers, dimmers and sensors, (and other modular components to be added/included) etc. as well as having other wired or wireless programming or joining/connecting/connection/advertising protocols, approaches, methods, techniques, technology, etc. that include cyber secure methods, approaches, techniques, etc. that could optionally permit programming changes or reprogramming, uploads of updates to the firmware and software, etc.

Embodiments of the present invention can incorporate the low-cost wireless control and monitoring into the drivers and sensors. This provides a wide-open way to interface with the energy efficient SSL with advanced sensors, controls and connectivity systems including without the need for internet protocol (IP) addresses (and typically, if so desired, using at most only one IP address) using most any type of entertainment device including old NTSC TVs, monitors and more modern do-it-yourself (DIY) gadgets including Arduino, Raspberry Pi, etc.

The present invention allows the ability to switch from remote (control) mode to manual mode simply by touching, in the case of a dimmer, a knob. Embodiments of the present invention can detect/sense motion and light and make informed, automatic decisions based on algorithms, however such algorithmic auto-tuning, automatic decisions can be easily overridden by the user. Additional developers can create additional hardware and software for these systems and expand the functionality and user-interface/experience/abilities/etc.

A graphical user interface is provided in some embodiments of the present invention, for example accessible as a web page or set of web pages that can be accessed using any web browser on any device. Such a graphical user interface can display all of the data sources, all of the controllable devices, and can provide remote control of any of the controllable devices in the system. Some embodiments provide for power monitoring and logging, for example measuring/monitoring input voltage and current, power consumption including both real and apparent power consumption and power factor of a single light source in the system or other device in the system, or for groups of devices in the system. These and other such GUIs can be imported to other formats such as, but not limited to, a converter box designed to work with NTSC TVs, HDTVs including smart HDTVs, computers, dedicated control/monitor blocks that can either have a built-in display or use a TV or monitor display, Arduinos, Raspberr Pis, smart phones, tablets (in Bluetooth or WiFi mode as well as wireless internet mode), and a vast host of other interfaces.

Some embodiments of the present invention can use low-cost smart/intelligent SSL drivers based on existing powerline, wired and wireless interfaces including AC powerline, 433 MHz, 868 MHz and 2.4 GHz wireless remote monitoring and control systems in addition to wireless solutions/options that use more expensive Bluetooth, ZigBee, IEEE 802-based, WiFi etc. as well as complete 0 to 10 V dimming control for LED dimmable drivers and CCFL and FL dimmable ballasts and other dimmers. The wireless systems can be easily modified to other frequencies if needed including, for example, in the International Science and Medical (ISM) mid to high MHz frequency range as permitted by the FCC. The monitoring and control systems can monitor all key parameters including, but not limited to, input current, input voltage, inrush current, voltage spikes, power factor, true input power, Volt-Amp (VA) input power, output current, output voltage, output power, output voltage, etc. The powerline communications can support, for example, X-10, Instcon, and HomePlug protocols, etc. In addition, open source protocols can be implemented.

Manual/Remote Mode feature with status indicators can also be provided in some of the embodiments with flexible manual override capabilities and user selectable setup features. Voice recognition and gesturing can also be implemented into versions of the present invention along with the wireless, wired and powerline choices.

Interfaces that support standards including Building Automation Control Network (BACnet) developed as an open, standard communication protocol by the American Society of Heating, Refrigerating, and Air-Conditioning Engineers (ASHRAE) and LON (LonTalk), a protocol developed by the Echelon Corporation later named as standard EIA-709.1 by the Electronics Industries Alliance (EIA) that have been established for building automation system (BAS) vendors, manufacturers, suppliers, etc. can also be implemented in the interfaces to the SSL drivers and power supplies to enhance and further enable the adoption of SSL luminaires in residential and commercial building automation. A purported primary feature of BACnet and LON is interoperability enabling multiple control systems and lighting systems manufactured by different vendors to work together, sharing information via a common interface. Some embodiments of the present invention allow for higher output powers than would normally be allowed by, for example, taking advantage of the additional power supplying capabilities of the ballast to supply full wattage as opposed to a reduced wattage that are typically needed for SSL to have the same output lumens. For example, during an emergency including, but not limited to a smoky environment or a need for more intense light, embodiments of the present invention could switch to a high energy/high power mode where more power/current was being used by the SSL and thus, in general, increasing the output lumens even if doing so may, depending on the situation, degrade (or not degrade) the ultimate lifetime of the SSL including but not limited to LEDs and/or OLEDs.

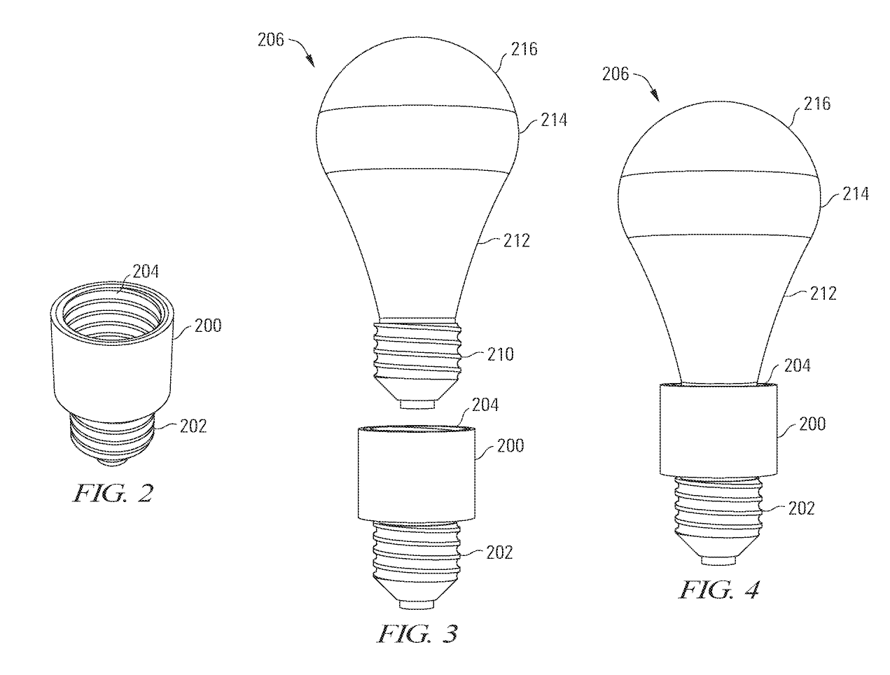

Turning now to FIGS. 2-4, some embodiments of the present invention include an in-socket solid state lighting-compatible controller/dimmer. Although any socket and any light source mounting technology can be used, the example embodiment of FIGS. 2-4 includes a male and female Edison E26 or medium screw base. The socket 200 includes a male Edison screw base 202 to connect to a light fixture, and a female Edison screw socket 204 to receive a solid state light 206. The socket 200 includes power supply/driver circuits, wireless control circuits, on/off/dimming circuits, monitoring/control circuits, etc. as desired. In some cases, power supply/driver circuits, wireless control circuits, on/off/dimming circuits, monitoring/control circuits are also or alternatively located in the solid state light 206. The solid state light 206 includes a male Edison screw base 210, a housing 212 that can emulate the familiar shape of an incandescent bulb if desired that can house circuits, heat sinks, sensors, etc. The solid state light 206 includes a circuit board housing 214 in which one or more circuit boards can be mounted supporting one ore more solid state lights of one or more colors, covered by a lens 216 that can include diffusers, filters, lenses, phosphor coatings, etc. as desired.

The present invention uses wireless signals to both control (i.e., dim) SSL (e.g., LED, OLED, QD) fluorescent lamp replacements (FLRs) and monitor the LED current, voltage and power. This LED fluorescent lamp replacement is designed to work directly with existing electronic ballasts and requires no re-wiring and can be installed in the same amount of time or less than changing a regular fluorescent lamp tube. This smart/intelligent LED FLR is also designed to be compatible with most daylight harvesting controls and protocols. Included, incorporated or optional sensors allow for relative light output to be measured and wirelessly reported, monitored, and logged permitting analytics to be performed. The FLRs can be of any size and length including both two foot and four foot T4, T5, T8 standard/nominal linear lengths (T12 sizes can also be used if deemed useful for FLR usage) as well as other form factors including but not limited to PL 2 pin and 4 pin, U shaped tubes, etc. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or Bluetooth or any type and flavor, ZigBee, ZWave, IEEE 802, WiFi, WeMo, etc., more than one of these, combinations of these, etc. In addition to occupancy/motion sensors, photo sensors and daylight harvesting controls, various embodiments support simple and low cost interfaces that allow existing other brands, makes, and models of daylight harvesting controls, photo sensors, occupancy/motion sensors to be connected to and control/dim the wireless LED FLRs. The LED FLRs can be switched on and off millions of times without damage as well as be dimmed up and down without damage. The wireless communications can be encrypted and secure. This LED FLR technology does not require or need a dimmable ballast (although the present invention will also work with dimmable ballasts, dimming ballasts, etc.) and works with virtually any electronic ballast including instant start, rapid start, programmed start, programmable start, pre-heat, dimmable, dimming, non-dimmable, 1, 2, 3, 4, 5, 6 and higher count lamp ballasts, etc.

The control code interoperability allows multiple control systems manufactured by different vendors to work together, sharing information via a common Web-based interface.

The present invention can use wireless signals to both control (i.e., dim) the SSL FLR and monitor the SSL current, voltage and power. Optional sensors allow for relative light output to be measured and wirelessly reported, monitored, and logged permitting analytics to be performed. Additional optional input power measurements allow total power usage, power factor, input current, input voltage, input real and apparent power to also be measured thus allowing efficiency to be measured. The wireless signals can be radio signals in the industrial scientific and medical (ISM) for lower cost and simplicity or Bluetooth, ZigBee, ZWave, IEEE 802, WiFi, WeMo, Wink. etc. either secure/encrypted or unsecure communications. In addition to occupancy/motion sensors, photo sensors and daylight harvesting controls, simple (or more complex, sophisticated, etc.) and low cost interfaces allow existing or other brands, makes, and models of daylight harvesting controls, photo sensors, occupancy/motion sensors to be connected to and control/dim the wireless SSL FLRs. These SSL FLRs are highly efficient.

Any and all types of buildings and residences, small or large, that have/use electronic ballasts or magnetic with linear fluorescent tubes or compact fluorescent tube types (e.g., PL 2 and/or 4 pin) can use and directly benefit from the present invention.

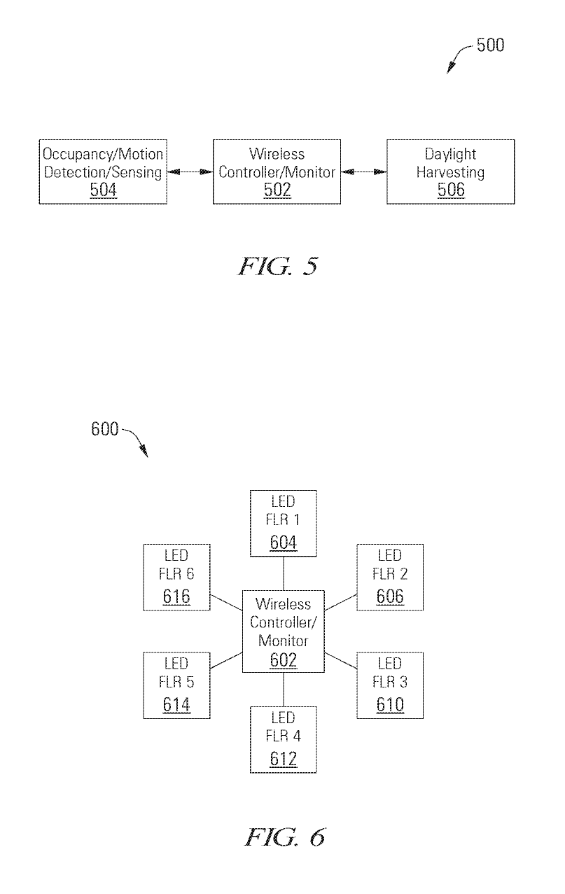

Turning now to FIG. 5, a block diagram depicts a lighting system 500 including a wireless controller and monitor 502 and sensors in accordance with some embodiments of the invention. Sensors can include, but are not limited to, occupancy/motion detectors/sensors 504 and daylight harvesting sensors 506.

As depicted in FIG. 6, the wireless controller and monitor 602 of a lighting system 600 (that can be the same wireless controller and monitor 502 as in FIG. 5, or a different wireless controller and monitor) feeds control signals to one or more SSL FLR's (e.g., 604, 606, 610, 612, 614, 616). Although six SSL FLR's (e.g., 604, 606, 610, 612, 614, 616) are depicted, any number of SSL FLR's can be addressed and controlled, and can have the same or different or multiple colors or light wavelengths. The wireless controller/monitor 602 can be interfaced to, for example, an intranet, the Internet, custom remote controls, autonomous controls, Bluetooth, etc. and can be securely encrypted or unsecure. In some embodiments, the SSL FLR's (e.g., 604, 606, 610, 612, 614, 616) are direct fluorescent lamp replacements that can be snapped in or connected to any existing fluorescent light fixture and turned on without requiring electrical re-wiring to install. This makes switching to SSLs/LEDs as simple as changing a light bulb/tube: no rewiring or special handling required. The SSL FLR's (e.g., 604, 606, 610, 612, 614, 616) can be powered by ballasts in, for example, but not limited to T8 (or T4, T5, T9, T10, T10, PL, etc.) lighting fixtures and used in rewired fixtures where AC power is supplied directly to the lamps.

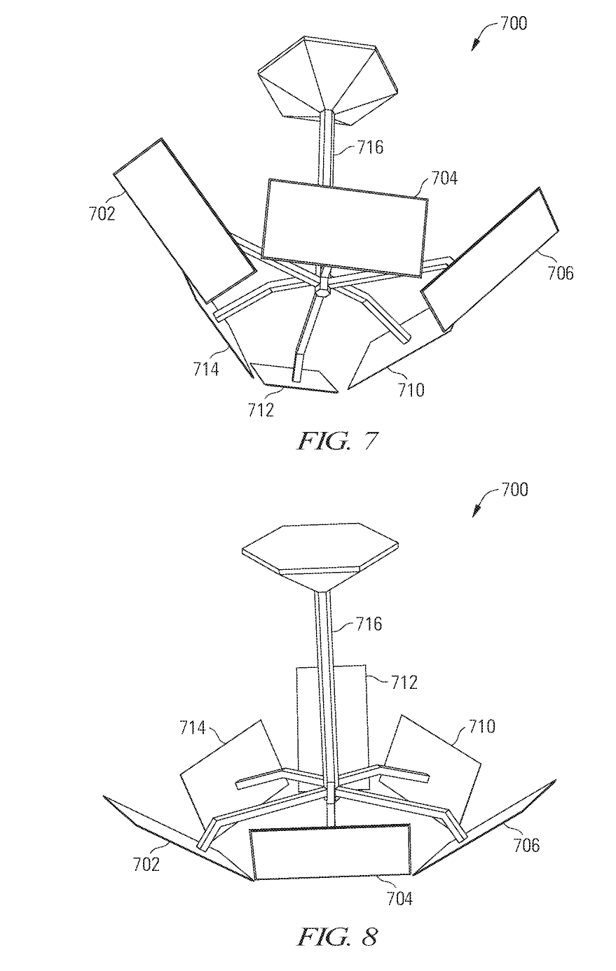

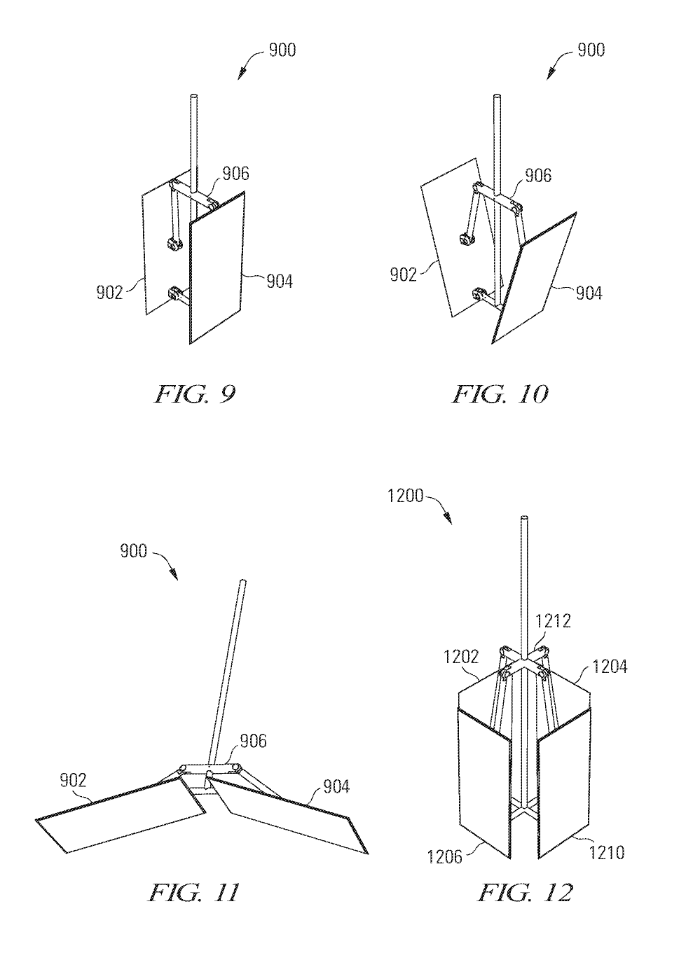

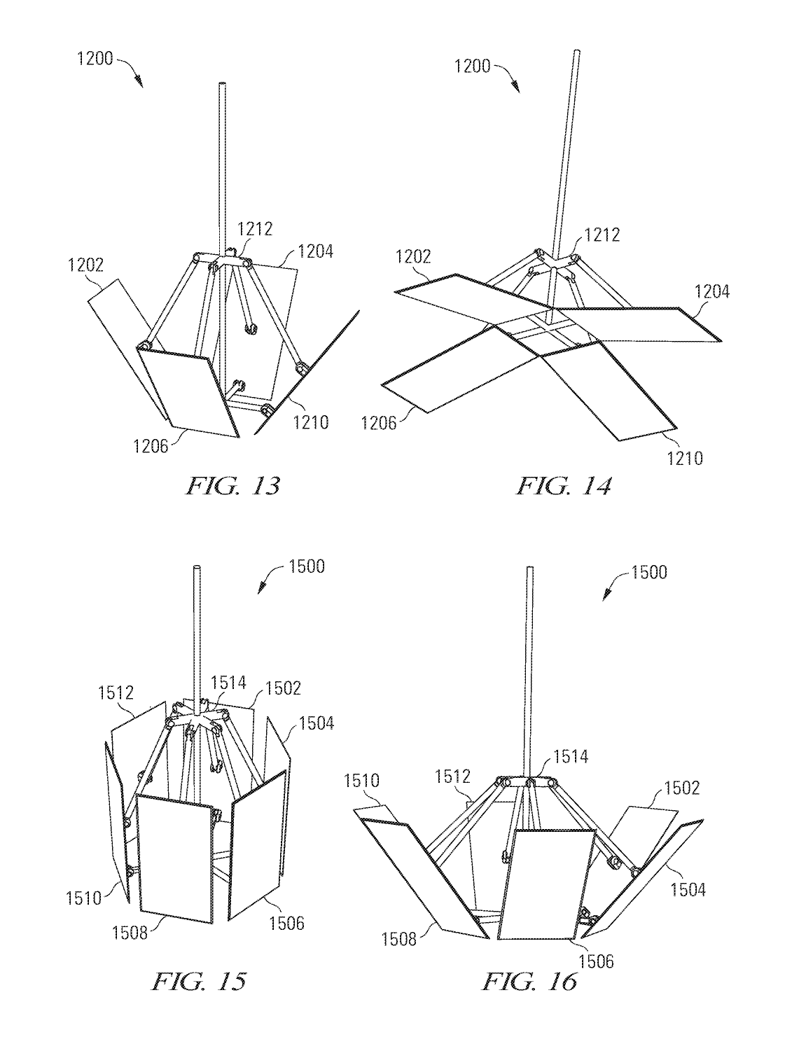

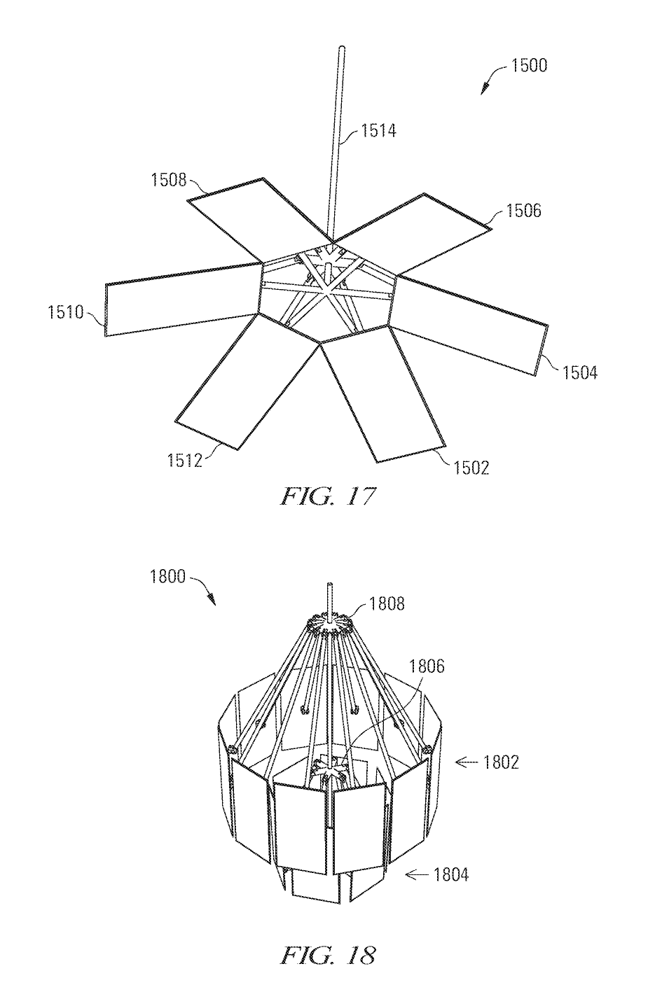

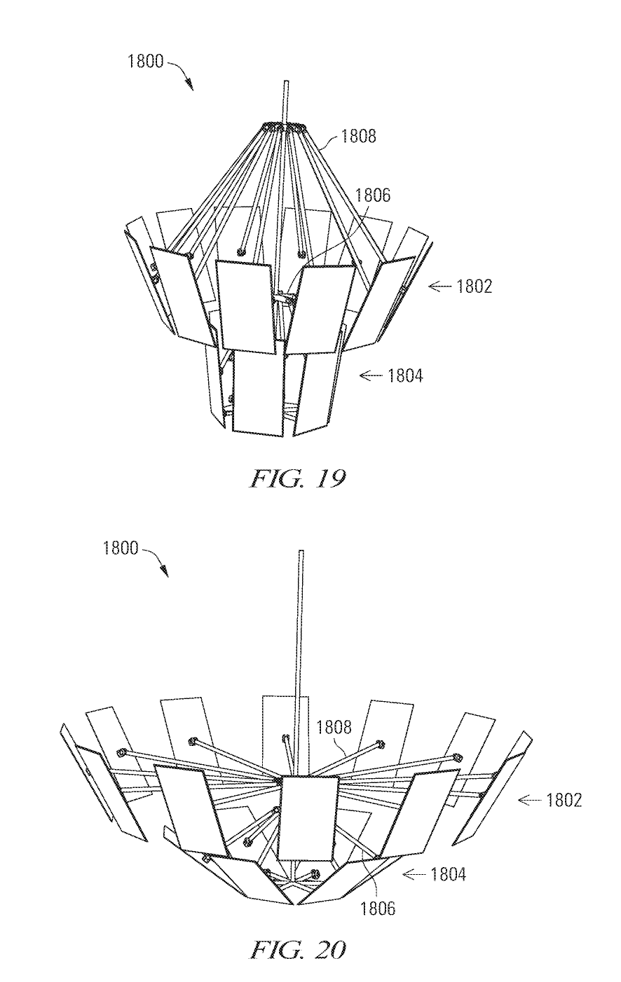

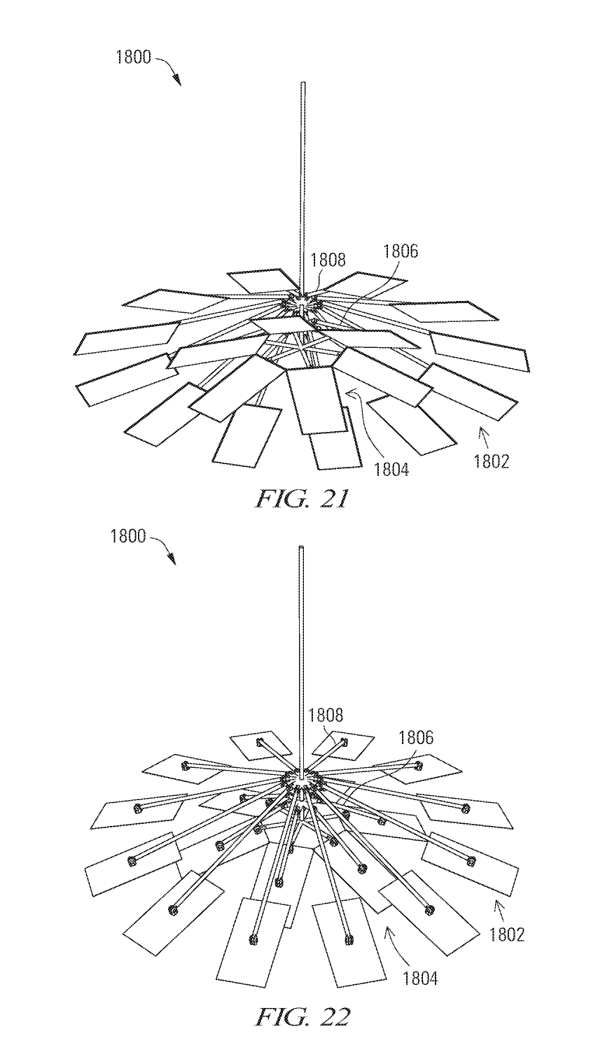

Turning now to FIGS. 7-22, some embodiments of the present invention include one or more multiple light emitting panels with fixed or movable mounts. For example, multiple panels can be mounted on moveable or articulating arms. In FIGS. 7-8, an SSL system 700 includes six light emitting panels 702, 704, 706, 710, 712, 714 mounted on a controllable and moveable mount 716. Like a blooming flower the SSL system 700 can be ‘folded’ to close and then opened to bloom. The light emitting panels 702, 704, 706, 710, 712, 714 can use monochrome, white, multi-color, color-changing, color-tuning, color adjusting, etc. LEDs, QDs and/or OLEDs or combinations of these, etc. Motors, gears, pulleys, chains, etc. may be used with the SSL system 700 to unfold, fold, rotate, move, translate. etc. the light emitting panels 702, 704, 706, 710, 712, 714. The light emitting panels 702, 704, 706, 710, 712, 714 (or petals of the blooming flower) may have any size or shape, may be symmetrical, asymmetrical, etc.

Any number of light emitting panels of any color or combination of colors can be included, and can also include point light sources if desired, as well as sensors, detectors, cameras, fans, reflectors, diffusers, etc. as desired.

Turning to FIGS. 9-11, an example SSL system 900 includes two light emitting panels 902, 904 mounted on movable arms 906 which can be adjusted to tilt the two light emitting panels 902. The mounting system can be adapted as desired to allow any range of motion, rotation, etc. Turning to FIGS. 12-14, an example SSL system 1200 includes four light emitting panels 1202, 1204, 1206, 1210 mounted on movable arms 1212 which can be adjusted to tilt the four light emitting panels 1202, 1204, 1206, 1210. Turning to FIGS. 15-17, an example SSL system 1500 includes six light emitting panels 1502, 1504, 1506, 1508, 1510, 1512 mounted on movable arms 1514 which can be adjusted to six light emitting panels 1502, 1504, 1506, 1508, 1510, 1512. Turning to FIGS. 18-22, an example SSL system 1800 includes two layers or levels 1802, 1804 of light emitting panels, mounted on two independent sets of movable arms 1806, 1808. In some embodiments, multiple attachment points are used on each light emitting panel to control position, tilt, etc. In some other embodiments, a single attachment point is used with a controllable mount, such as a motorized gimbal, on each light emitting panel, enabling each light emitting panel to be independently positioned, tilted, rotated etc.

The present invention may be used as a light source for multiple purposes including as a reading lamp, as a task lamp, as an ambient lamp, as a circadian rhythm regulator and adjuster, etc., an entertainment and mood lamp, emergency indicator or other indicator, guide light by shining or flashing different colors to indicate one or more paths simultaneously, sequencing including temporally sequencing the lighting to indicate directions to follow/take/etc., turning different parts including light source parts to indicate a direction or path, etc. to follow, a status indicator by shining various colors in various locations according to conditions to be identified, etc. Such emergency or identification or guide or other functions can be performed in combination or conjunction with other functions, including simultaneous lighting such as combining white illumination with colored indicators.

An example of the present invention includes, but is not limited to, a light source for train, bus, airplane, ship, boat, yacht, recreational vehicle (RV), SUV, limousine, van, submersible vehicles including, but not limited to, submarines, Navy boats, commercial jets, plant growth, etc.

The present invention can be used to produce various effects in, for example, a long distance travel by train, boat or plane in which the users can choose from soothing or exciting colors, certain wavelengths of light to help induce, reset, etc. circadian rhythms and melatonin production or suppression, etc., to address SAD conditions, to provide one or more types of light therapy, to provide a calming or exciting ambiance, to affect mood, emotions, sleep, rest, enjoyment, ambiance, environment, relaxation, alertness, focus, attention span, etc.

The present invention can be used, for example, on a commercial airplane to allow the passenger to adjust the local lighting by using, for example, Bluetooth, WiFi, or any other wireless method, way, protocol, etc. to, for example, communicate with the light/lamp to dim, change color temperature, change color or combinations of colors to change white color temperatures, to provide alerts, alarms, mood setting, light therapy, turn off, turn on, tilt, and/or combinations of these, etc.

The present invention can be attached/embedded/incorporated/integrated/etc. into a fan, including, but not limited to, a ceiling fan that in some embodiments can change speed and light intensity and/or colors as it rotates. The LED and/or OLED and/or QD lighting can be incorporated/attached/embedded/etc. on one or both sides of the fan blades as well as other parts of the fan.

As an example of the present invention, a 12 channel driver can separately and independently supply and wirelessly control (i.e., dim) each color of four RGB or three RGBA or RGBW SSL panels as well as 12 individual monochrome (e.g., white or other color) SSL panels, and/or a mix and match combination of both color, color-changing and/or white SSL panels. Of course more or less channels can be implemented.

The present invention can implement building block power supply approaches that can be mated with and sold with SSL panels, lightbars, lamps, strings, etc. as SSL lighting kits.

The driver electronics for the color changing/tunable SSL lighting allow, among other things, flexible, selectable lighting including warm, cool, daylight, etc., white light choices for residential consumers and business customers. These drivers also permit and support remote dimming, control, monitoring, data logging as well as analytics.

All of the above can be wirelessly interfaced, controlled and monitored using, for example, smart phones (i.e., iPhones, Androids), tablets (i.e., iPad, iPod touch, Droid. Kindle, Samsung, Dell, Acer, Asus, etc. tablets), laptops, desktops and other such digital assistants.

The universal drivers can also support Triac and 0 to 10 Volt dimming as well as optional powerline (PLC) and wired and/or wireless remote control. The 10 to 50 V DC input power supply can support 0 to 10 volt dimming and can have optional wired and/or wireless control and monitoring.

Some embodiments of the present invention include power supplies and drivers specifically focused on OLEDs that address both the rather unique properties of OLEDs compared to, for example, even LEDs. In general, both OLEDs and LEDs should be current control driven—that is to safely operate both LEDs and OLEDs the power source should be current controlled and regulated as opposed to, for example, applying a constant, regulated voltage to the OLEDs or LEDs.

In general LEDs are point sources made up of certain mixtures/alloys of III-V semiconductors based, for example, binary gallium arsenide (GaAs) and gallium nitride (GaN) forming ternary alloys such as, but not limited to, aluminum gallium arsenide (AlGaAs) and aluminum gallium nitride (AlGaN). These and other such alloys allow a vast number of nearly single wavelength with a relatively small full width at half maximum (FWHM) optical emission which can include optical emission wavelengths that are visible to the human eye and are perceived as colors. White light LEDs can be achieved in a number of ways including color combining single color LEDs such as red, green and blue LEDs or using phosphors or QDs to perform wavelength conversion(s). LEDs are two terminal point source emitter devices which emit light when an electrical stimulus is applied. LEDs can be easily formed into parallel and/or series configurations occupying relatively small areas. OLEDs, on the other hand, are made of molecules that also emit light when electrical stimulus is applied. However, unlike LEDs, OLEDs are designed and configured as area sources and not point sources. There are a number of ways to also obtain white light OLEDs including homogenously mixing at, for example, the nanometer level red, green, blue or red, yellow, blue or other combinations of OLEDs, stacking layers of various colors of OLEDs vertically on top of each other, having stripes of various colors placed laterally close to each other, etc.

With LEDs, typically both the cathode and anode are available for, for example, each individual LED color to be connected in parallel and/or in series either individually or in groups/arrays/etc. such that often there are only two electrical power connections from the power to the LEDs and therefore the power supply/driver output and output connection configurations are often much simpler and more universal for LEDs than OLEDs. Of course, with the continued widespread growth and use of LEDs, there are and will be numerous exceptions to just the two connections per LED fixture or luminaire although such a generalization usually applies to LED lights and lamps such as, but not limited to, GU10, MR16, A Lamps, PAR 30, PAR 38, R30, T4, T5, T8, T9, T10, T12, PL 2 and 4 pin, and other SSL/LED/OLED/QD/etc. lamp replacements. Unless there is only one OLED panel that has only two electrode connections for a given lighting application, an optimized power supply design for multi-electrode (i.e., more than two electrodes) OLED panel(s) can involve consideration of a number of factors including, among others, ensured proper current sharing, size/gauge of wires used, over-current protection, over-voltage protection, individual OLED panel fault detection/correction, OLED lifetime aging, OLED differential color aging (e.g., blue color lifetime being lower than typically other OLED colors), whether to put multiple OLED panels in parallel or series or combinations of both, voltage drops in the interconnect wiring between the power supply and the OLED panels for OLED fixtures and luminaires.

The present invention provides solutions that include OLED lighting kits that would include power supplies/drivers, connectors/interconnects and OLED panels that are all designed to be mated to each other. In addition interfaces can provide significant assistance and aid in connecting multiple OLED panels to power supplies and drivers safely and correctly. This simple interface will use an OLED identification system that allows the power supply/driver and each of the individual OLED panels to communicate with each other in a similar but much simpler (and slower) fashion as, for example, the Telecommunications Industry Association/Electronic Industries Alliance (TIA/EIA) 485 also known as RS485 interface (which is also the basis of, for example, Modbus, Profibus, DMX512, etc.) 2 wire systems.

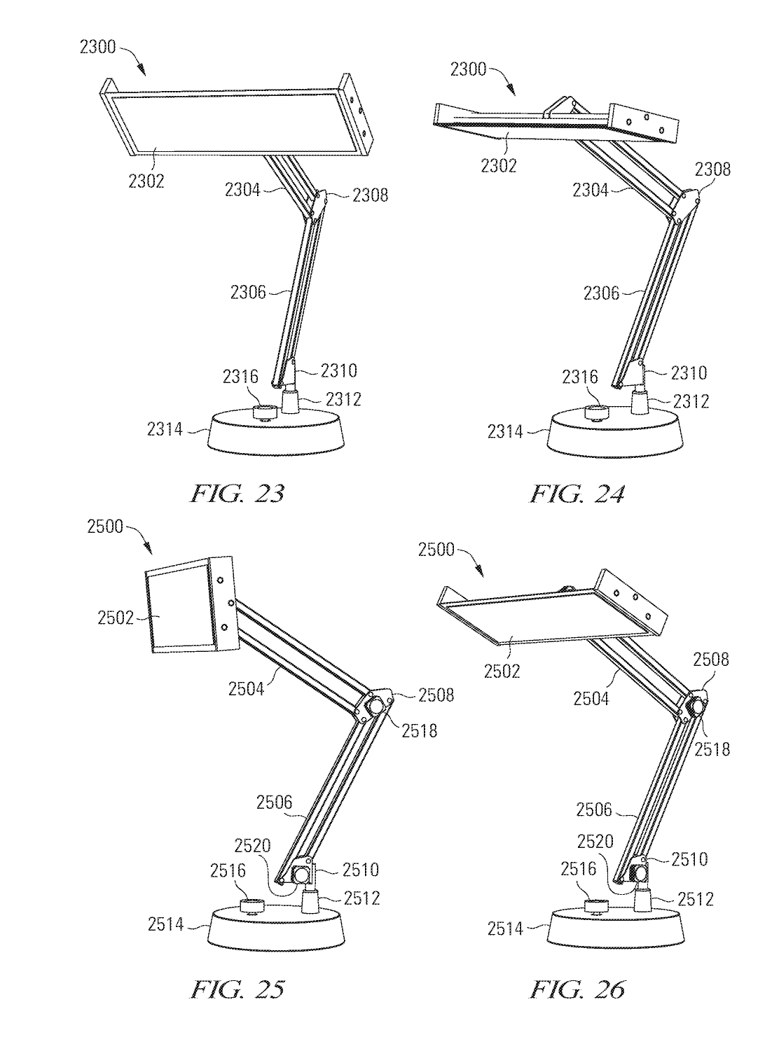

Turning to FIGS. 23-28, articulating desk lamps with one or more rotatable solid state lighting panels are depicted in accordance with some embodiments of the invention. In FIGS. 23-24, a desk lamp 2300 includes one or more support members 2304, 2306 connected by hinges 2308, 2310 and mounted by a rotating sleeve 2312 to a base 2314, allowing the lighting panel 2302 to be pointed in any desired direction. The support structure is not limited to the articulating arm assembly shown in FIGS. 23-24, but can include any device or assembly suitable for positioning and orienting the lighting panel 2302, such as, but not limited to, a ball and socket chain, gimbaled arm, etc. A power supply/dimming control circuit can be provided to power and control the lighting panel 2302 and can be positioned in any suitable location, such as in the base 2314. An IR receiver (not shown) and/or other wired or wireless connection can be provided to link the desk lamp 2300 to other parts of an automation system, enabling the illumination level, color, on/off state to be controlled, scheduled, sequenced, etc.

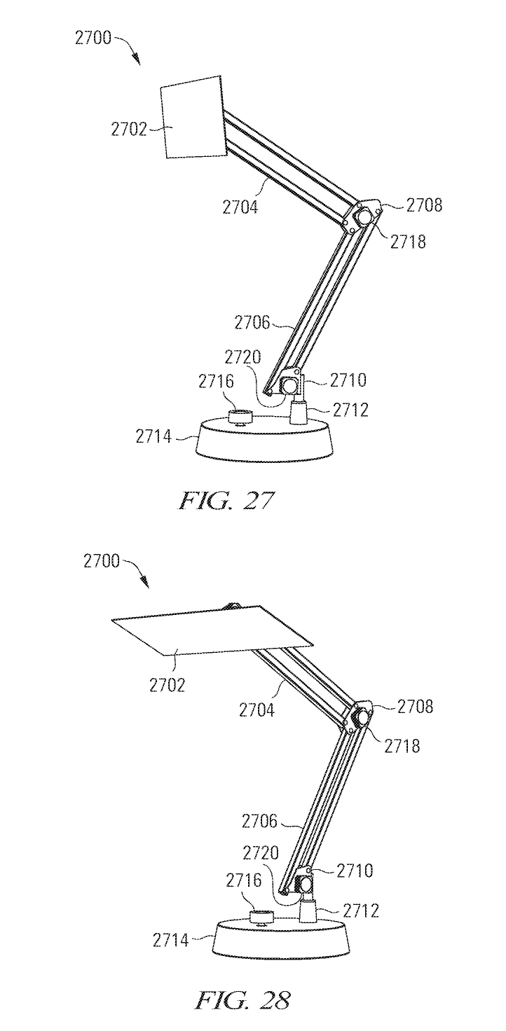

Turning to FIGS. 25-26, in some embodiments of an articulating desk lamp 2500 the position and/or orientation of the lighting panel 2502 can be automatically controlled. The desk lamp 2500 includes one or more support members 2504, 2506 connected by hinges 2508, 2510 and mounted by a rotating sleeve 2512 to a base 2514, allowing the lighting panel 2502 to be pointed in any desired direction. The support structure is not limited to the articulating arm assembly shown in FIGS. 25-26, but can include any device or assembly suitable for positioning and orienting the lighting panel 2502, such as, but not limited to, a ball and socket chain, gimbaled arm, etc. A power supply/dimming control circuit can be provided to power and control the lighting panel 2502 and can be positioned in any suitable location, such as in the base 2514. An IR receiver (not shown) and/or other wired or wireless connection can be provided to link the desk lamp 2500 to other parts of an automation system, enabling the illumination level, color, on/off state to be controlled, scheduled, sequenced, etc. In some embodiments the position can be controlled by motors (e.g., 2518, 2520) such as stepper motors, DC motors or other actuators. For example, IR receivers are provided on the motors (e.g., 2518, 2520) and/or motor controllers in some embodiments to remotely control/schedule motor movements. Encoders, decoders, etc. can be used to monitor, track, store, record, remember, replay, spin around, spin in circles, control speed, angular speed, velocity, angular velocity, movement, angular position, angular position, acceleration, angular acceleration, spinning at various speeds including relatively very slow to relatively fast speeds, move to, etc. existing and previous positions, locations, etc. and can also be used to respond to, interact with, track, move, position, speed, velocity, acceleration, pitch, etc. the present invention depicted in FIGS. 25-26 based on, for example, but not limited to one or more inputs, information, sensing, detection, time of day, date, ambient temperature, light intensity, movement, proximity, location, GPS information, atomic clock information, people animals, plants, insects, heat, cold, temperature, thermal gradients, thermal leakage, fire, smoke, gases, etc.

Turning to FIGS. 27-28, the lamp 2700 can have any shape, configuration, size, materials, etc. For example, a light emitting panel 2702 can be mounted in a support frame as in FIGS. 23-26 or mounted more directly in a sleek form factor as in FIGS. 27-28. The desk lamp 2700 includes one or more support members 2704, 2706 connected by hinges 2708, 2710 and mounted by a rotating sleeve 2712 to a base 2714, allowing the lighting panel 2702 to be pointed in any desired direction. The support structure is not limited to the articulating arm assembly shown in FIGS. 27-28, but can include any device or assembly suitable for positioning and orienting the lighting panel 2702, such as, but not limited to, a ball and socket chain, gimbaled arm, etc. A power supply/dimming control circuit can be provided to power and control the lighting panel 2702 and can be positioned in any suitable location, such as in the base 2714. An IR receiver (not shown) and/or other wired or wireless connection can be provided to link the desk lamp 2700 to other parts of an automation system, enabling the illumination level, color, on/off state to be controlled, scheduled, sequenced, etc. In some embodiments the position can be controlled by motors (e.g., 2718, 2720) such as stepper motors, DC motors or other actuators. For example, IR receivers are provided on the motors (e.g., 2718, 2720) and/or motor controllers in some embodiments to remotely control/schedule motor movements. Encoders, decoders, etc. can be used to monitor, track, store, record, remember, replay, move to, etc. existing and previous positions, locations, etc. and can also be used to respond to, interact with, track, move, position, etc. the present invention depicted in FIGS. 27-28 based on, for example, but not limited to one or more inputs, information, sensing, detection, time of day, date, ambient temperature, light intensity, movement, proximity, location, GPS information, atomic clock information, etc.

It should be noted that the basics and essentials of the OLED desk lamp including color, multicolor, color plus white, multicolor plus white, various colors and ‘shades’ of white, amber and/or blue OLEDs and/or LEDs or QDs, etc., combinations of these, etc. can be modified to produce and be used in, for example, under-cabinet lighting for kitchens, bathrooms, vanities, etc. as well as accent and sconce lighting.

Additional features and functionalities can be added to the OLED desk, task and table, sconce, under-counter and over/above-counter lighting including but not limited to proximity detection, daylight harvesting, voice recognition, voice detection, proximity, heat, thermal, other ways, methods, techniques, approaches, etc. discussed herein, combinations of these, etc.

The OLED power supplies and example associated innovative lighting and luminaire applications including the circadian rhythm cycle regulation lighting system can also be portable OLED or LED lighting that can be charged by AC, direct current (DC) or solar power/energy sources. Such innovative OLED and LED lighting can be used for camping, emergency, outdoors, indoors, and general portable, etc. compact and rechargeable illumination applications including circadian rhythm regulation, SAD and other types of light therapy applications in these varied environments, etc. With properly designed high efficiency power supplies/drivers, portable OLED and LED lighting sources provide highly innovative, attractive, flexible and even colorful and also entertaining lighting as well as being lightweight and able to support novel shapes and form-factors while still providing circadian rhythm cycle regulation that can be individually modified and adjusted for these and other (e.g., work time, work space, shift time, etc.), environments.

The present invention includes OLED power supplies and associated innovative OLED lighting for desk, and task applications and innovative color changeable OLED RGB (or RYB, RGBA, RTBA, RGBAW, RGBYW, etc. and/or additional colors, etc.) power supplies and drivers that can be produced cost-effectively with excellent performance, efficiency, efficacy, etc. The embodiments of the present invention are very flexible in design and application space.

The present invention includes power supplies for OLEDs, LEDs, QDs, etc. including ones designed for universal AC or DC input voltages and Triac and other dimming formats including 0 to 10 V, powerline, wireless, etc. Such power supplies can be adapted to be highly efficient—in some power supply/driver cases of close to 90%, even with relatively low output voltage (˜6.3) and relatively high current (close to 1 amp) for a ˜6.3 Watt OLED lamp output in an example embodiment. Embodiments of the present invention include a number of high performance power supplies and drivers for both monochromatic and multiple color/color changing/color tunable OLED lighting panels, including for example 12 channel common anode and/or common cathode OLED drivers that can be individually addressed and controlled/dimmed by wired and wireless interfaces and smart dimmable OLED desk/task lamps. Matched and mated power supplies/drivers for OLED and OLED panel kits can also be used for:
Highly efficient OLED lighting.
Flexible OLED lighting.
Do-It-Yourself (DIY) building block kit products to significantly expand the usage of OLED lighting applications and markets.
Smart/Intelligent OLED products
Wide range of AC and DC power supply/driver for OLEDs products
Color changing OLED products
Low, medium and high power OLED products
Low cost OLED power supplies and drivers
Niche OLED products aimed at specialized and specific applications, products and markets
High performance OLED products
Task/table/kitchen/closet/compartment, sconce, accent lighting OLED products
Individually personalized OLED products
Energy saving LED light
Color changing
Color tuning
Voice command
Gesturing and proximity detection
Health and Happiness and Entertainment
Retrofit or new construction

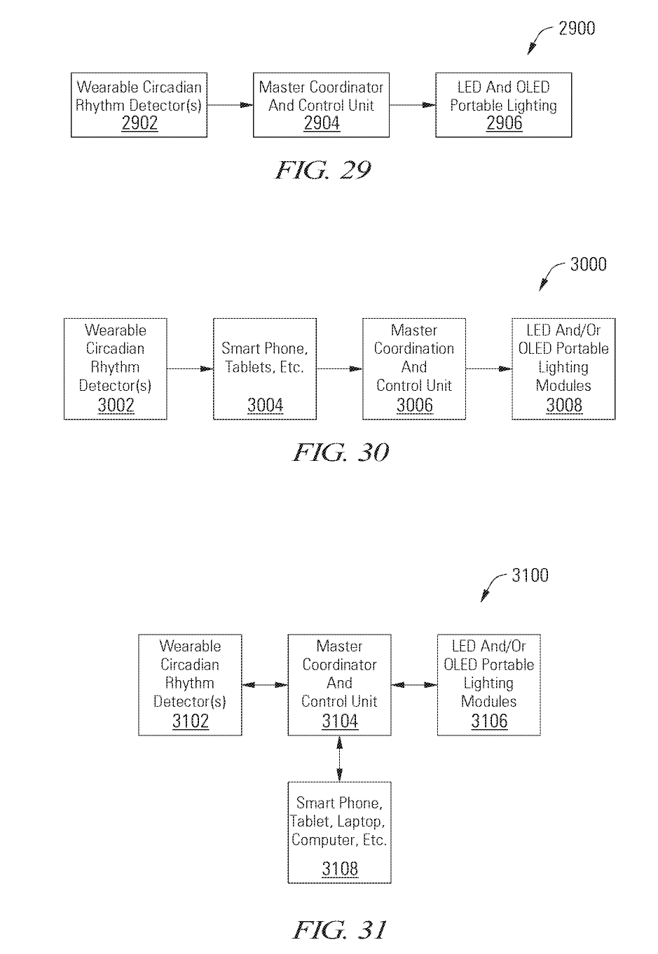

Turning now to FIG. 29, a block diagram depicts a circadian rhythm management lighting system 2900 with a wearable monitor 2902 in accordance with some embodiments of the invention. In some embodiments, the wearable monitor 2902 is a circadian rhythm detector or detectors. A master coordinator and control unit 2904 receives data from the wearable monitor 2902 and controls LED and OLED lighting 2906, in some embodiments comprising portable lighting, based at least in part on the data sensed by the wearable monitor 2902 including FitBit, Apple, Nike, etc.

In an example embodiment of the present invention, portable wireless controlled lighting for the circadian rhythm regulation system can be set to white, blue (for wake-up), green, red, yellow (for blue-free light to promote sleep) and amber-orange (also for blue-free light to promote sleep).

To appropriately synchronize daily rhythms in behavior, physiology and brain functioning with environmental time, terrestrial species have evolved an endogenous, circadian timekeeping system. Circadian rhythms are generated by a hierarchy of central and peripheral oscillators with the suprachiasmatic nucleus (SCN) of the anterior hypothalamus acting as the master circadian pacemaker. The circadian system evolved such that environmental light input from the retina synchronizes internal timing, with the daily environmental cycle of sunlight and darkness as the primary time setter and keeper.

The advent of artificial lighting has led to unnatural light exposure, and persistent pattern changes have impacted circadian rhythms and sleep physiology. Numerous findings indicate that these changes have led to some degradation of mental and physical health among human populations. For example, flight attendants frequently traveling across time zones exhibit gross cognitive deficits associated with reductions in temporal lobe structures. Likewise, numerous studies indicate that circadian disruption leads to an increased incidence of cancer, diabetes, ulcers, hypertension and cardiovascular disease, and a degradation of mental health. Finally, it is clear that exposure to artificial light at night causes circadian rhythm misalignments leading to cognitive decline, increased incidence of depression and anxiety disorders, and a host of metabolic disorders. There are concerns regarding circadian rhythm misalignments as they are known to affect response time, judgment and planning, as well as psychomotor skills, and can increase the prevalence of certain illnesses and chronic issues.

By developing strategies to correct/mitigate disruptions to circadian function and misalignment between endogenous cycles in circadian and sleep physiology with the external environment (e.g., following jet lag, shift work, night work, etc.), one can recover diminished human performance as well as improve human health, reduce risk of disease, and enhance cognitive functioning and performance. Strategies employed to date using pharmacological approaches or bright light presentation have been largely ineffective, as chronotype (e.g., ‘lark’ or ‘owl’), circadian phase and amplitude, and other variables that vary largely across individuals are not considered in the treatment regimen. For example, a wearable device can be used with a wireless system that can be utilized as a personal circadian rhythm monitor and regulation device capable of rapidly realigning the circadian rhythm of users to the local environment. In other situations the system adjusts the user to the work, mission or sleep cycle requirements, leading to improved sleep and performance. The lighting system 2900 continuously measures and collects data indicative of circadian phase and uses these data to drive the presentation of light of appropriate wavelengths during optimal times in the circadian cycle known to maximize circadian adjustment and sleep quality. Additionally, the data the device collects is self-reported with data from other wireless monitors of sleep quality for periodic examination of cognitive function and decision making to further enhance light presentation.

An integrated solution of circadian rhythm estimation and light-based circadian rhythm adjustment allows effective regulation of circadian rhythms and avoidance of circadian misalignment, leading to improved health, sleep and performance. The present invention includes an optional integrated wearable device (e.g., 2902) coupled with a wireless system that can be utilized as a personal circadian rhythm monitor and regulation device/system capable of rapidly realigning the circadian rhythm of service members to the local environment or, depending on the situation, aligned to provide an artificial environment to ensure both the rhythm of light and user are in sync with the rhythm of activity and sleep, leading to improved sleep and performance. This device and system continuously measures and collects physiological signals, synthesizes them into continuous circadian rhythm estimation, monitors the ambient light to detect circadian misalignments, and controls artificial light presentation. Secure storage of the data set is on the device/system to allow the user and, with proper approval(s), health professionals to perform further evaluation. The data set includes collected physiological signals, estimated circadian rhythm data, and circadian light monitor control information, as well as user input on self-assessed sleep quality and alertness. The host system can include mobile devices including but not limited to Smart phones, user/operator control stations or integrations into platform avionics suites and work environments. Integration, portability and interoperability across these platforms and their advanced performance management/training environments are important considerations. The present invention can also be used for SAD and other light therapy applications.

The present invention is on lighting systems that can interface with technologies to regulate circadian rhythm for health and performance that can, for example, include a low cost, human wearable system that includes at least two and typically/optionally more than two connected components: 1) the first (e.g., 2902) accurately monitors the user's circadian rhythms to produce reliable circadian phase and amplitude markers and 2) the second (e.g., 2906) is an integrated light presentation unit whereby the timing, wavelength, and intensity of light is driven by the data collected from the first component. The present invention can also be used for SAD and other light therapy applications.

The present invention can be used to increase the effectiveness of utilizing an integrated system and its impact on real-world outcomes of circadian rhythm regulation, sleep, and alertness including accuracy, reliability, and usability of the devices in the system as well as those suffering from SAD and other maladies, diseases, disorders, illnesses, dementia, muscle, physiological or brain disorders, etc.

The present invention can be also be utilized for personal circadian rhythm regulation by synthesizing physiological signals into a circadian rhythm estimate and adjusting the circadian rhythm control light input based on the estimate. The lighting system 2900 seamlessly integrates with other peripheral device(s), web-based and Smartphone applications, and provides additional feedback and monitoring tools for long-term health assessment. In addition, the lighting system 2900 has numerous uses for various commercial consumers for improving general health of shift workers, students in classrooms, hospital patients, and workers in controlled lighting areas, sleep deprived individuals and aviation operators, including both aircrew and passengers.

Implementations of the present invention include a master coordinator/controller (MCC) 2904 that wirelessly receives information as input from the circadian rhythm detector device(s) (e.g., 2902).

The present invention includes wireless commands to control the lighting sources to be able to regulate and entrain the circadian rhythm cycle. Wireless control signals can be transmitted from the MCC 2904 to the lighting sources 2906 to include light emitting diodes (LEDs) and organic light emitting diodes (OLEDs) and quantum dots (QDs) using appropriate libraries, class(es), frameworks, object oriented languages, etc.

The present invention includes cost-effective, portable, accurate, and transparent methods to monitor, assess, maintain, regulate, realign, and if necessary, reset the circadian rhythm of a person to help ensure optimum health and performance.

The Master Coordinator Control (MCC) unit 2904 can be adapted to store, interpret, analyze, and transmit control signals to the lighting modules 2906 to apply the range of wavelengths necessary to modify (e.g., for maintaining, resetting and entraining) circadian rhythms.

Turning now to FIG. 30, in some embodiments the circadian rhythm management lighting system 3000 with a wearable monitor 3002 is adapted to communicate wirelessly with controllers such as a smart phone, tablet, 3004 etc. A master coordinator and control unit (MCC) 3006 communicates with the wearable circadian rhythm detector(s) 3002 via the smart phone/tablet 3004, with either one-way or two-way communications with the smart phone/tablet 3004 also acting as an optional method and way to display circadian rhythm and the circadian rhythm regulation system information and data, including those for the control and monitoring of the lighting and other environmental information. Other embodiments of the present invention can also be used for SAD and other light therapy applications.

The light sources 3008 include light emitting diodes (LEDs) and organic light emitting diodes (OLEDs) and quantum dots (QDs) including ones that are designed to install in conventional legacy light sockets and fixtures and/or portable light sources. Embodiments of the present invention can be implemented whereby the MCC 3006 communicates with wirelessly-controlled lighting 3008 that fits directly into conventional legacy light fixtures (without any changes in the electrical wiring or overhead lighting or lamp design). These LED and OLED lighting sources 3008 can change from (non-color) ‘white’ light illumination to any color combination of white light plus primary colors such as, but not limited to, red, green, blue (RGB) or red, green, blue, amber (RGBA) or other color temperatures of white depending on the needs indicated by the MCC unit 3006. The MCC 3006 or other controllers control features and functions including alarm clock mode, scheduling, synchronization with local time, daylight harvesting and occupancy sensing, etc. These LED and OLED and/or QD light sources are inherently portable, can be fully deployed typically in a time frame of minutes and is easily system integrated to work locations in conjunction with wearable circadian rhythm (CR) devices to provide light feedback for the circadian rhythm regulation and performance systems. In addition they are rugged, highly reliable, provide controlled dimming and can withstand repeated on/off cycles with no impact on life expectancy. In example embodiments with three color red, green, blue (RGB) or RGB plus amber (RGBA) OLED panels, each individual color can be obtained by turning off the other two colors. To facilitate wake onset and morning circadian phase resetting, a lighting choice with a significant blue color component is selected. To promote sleep onset and permit the nightly evening rise in melatonin a color choice essentially devoid of blue color is selected.

Firmware and software frameworks for bioinformatics, signal processing and interpretive feedback control can be used with the present invention. The software framework can be designed to be interoperable and multiplatform compatible, and incorporate protections for personally identifiable information and health care privacy regulations and to run on a number of platforms including smartphones and tablets running iOS, Android, and Windows Phone operating systems, computers and laptops running Windows, Linux and Apple operating systems as well as having web interfaces. All data regarding individual users can treated and designed to be kept private with encryption and tamper-resistant access permission.

Alternatives and complimentary control effectors such as acoustic spectra, magnetic fields, acupressure, electrical signals, or aromatics can also be included. The wearable circadian rhythm detector 3002 can include any suitable sensors, such as, but not limited to, motion sensors or biosensors to track sleep patterns, heart rate sensors, muscle movement sensors, brain activity sensors, blood pressure sensors, oximeters, etc. The present invention can be used in environment(s) that can be highly variable (e.g., while sleeping, traveling, portable locations, etc.) as well as fixed environments (home, barracks, longer-term temporary quarters and housing, etc.).

The functions of the system can be implemented and distributed among system elements in any suitable manner. For example, as depicted in the example embodiment of FIG. 31, some embodiments of a circadian rhythm management lighting system 3100 include a wearable monitor 3102, LED and/or OLED portable lighting modules 3106 or other light sources, and a master coordinator and control unit 3104 in direct communication with smart phones, tablets, laptop computers, other computers 3108, etc. Notably, in some embodiments the user can also self-report information using the smart phone/tablet 3108 which can also act as an optional way to display circadian rhythm and the circadian rhythm regulation system information and data including for the control and monitoring of the lighting and other environmental information.

The present invention lighting allows virtually any level and ‘size’ of lighting from highly compact lighting that is only a few inches square weighing much less than one pound that can be powered by, for example, batteries to SSL/LED lighting that can be quickly and easily installed in bedrooms, entire houses and apartment buildings to office buildings of practically any size.

Implementations of the present invention allow comparison of circadian rhythm or phase information from commercial off the shelf (COTS) systems whether currently known or developed in the future, as well as devices with well-established markers of circadian phase, including dim light melatonin onset (DLMO) through salivary measures and sleep midpoint analysis.

Implementations of the master coordinator/controller (MCC) wirelessly receive information as input from the circadian rhythm device using any means, including but not limited to WiFi. Bluetooth of all types and flavors, ISM, WeMo, Wink, and Near Field Communications with added channels and/or drivers as desired. The MCC receives signals from smart phones, tablets, laptops, desktops, etc., and the wearable circadian rhythm detection device(s) are in some embodiments able to communicate with, for example, a smart phone, tablet, etc. Sensors, such as cameras and motion detection, can also be used in embodiments of the present invention. Industrial, scientific and medical frequency (ISM) bands and additional sensors as desired can be included in the MCC module. Smart Phone+MCC modules that are portable inexpensive, high powered, optimized can also be used. Software apps can be used to gather, transfer and transmit the pertinent information from the wearable circadian rhythm sensor(s) that is periodically or continuously transmitted to the mobile device and MCC module.

The present invention allows for the ability to integrate, log, archive and catalog data. Data management for collected physiological signals, estimated circadian rhythm, user performance metrics and circadian light modifier control signal information can be used to determine the storage details of how and where the collected physiological signals, estimated circadian rhythm, circadian light control information, the sensor(s) information, the information gathered from the circadian rhythm detector(s), and the control status information along with date, time and location stamps is stored (e.g., in Flash memory, solid-state drives, USB ‘thumb’ drives, SD cards, hard drives, etc.), hard drives, and other types of storage devices. This information can also be synced up to store on additional mobile devices, PDAs, computers, laptops, etc. to, among other purposes, allow health professionals (with privacy protection) further evaluation.

Example features and functions including, as an example, an alarm clock mode with blue wavelength light content to facilitate waking and to and maximize circadian rhythm phase alignment which could also contain amber wavelength or other wavelengths suitable for use near or at or even during sleep time including in hospital, other care-giving facilities, dormitories, schools, overnight camps, military installations, retirement homes and facilities, convalescent facilities, urgent care facilities, recuperation locations and facilities including temporary, mobile, and permanent ones, etc., combinations of these and other discussed herein, etc.

In some embodiments, timing of light presentation and wavelength can be run through a simulation to determine the anticipated impact on circadian phase based on existing models of human circadian functioning. The MCC can be modified or adjusted accordingly if there is incongruence between the timing of light presentation and the required adjustments in circadian phase.

The white plus color changing lighting or white changing plus color changing light can be controlled such that, for example, the white and blue LEDs can be selected (enabled) or deselected (disabled) depending on the phase of the circadian rhythm and other measured and available signals and information or to support SAD or other light therapies.

Wireless commands are used to control the lighting sources to regulate and entrain the circadian rhythm cycle. For example some embodiments can use wireless-controlled white plus color-changing or white color changing plus color-changing LED and/or OLED lighting (including, but not limited to, A-lamp, PAR 30, PAR 38 R30, R40, MR16, GU10, both high and low voltage track lighting, magnetic lighting, 1 ft., 2 ft, 3 ft., 4 ft., 5 ft., 6 ft., and longer linear fluorescent lamp replacement LED tube lamps, PL 2 and 4 pin, U shaped fluorescent lamps, etc., combinations of these, sconces, under-cabinet, over cabinet, wall lights, ceiling lights, night lights, marker lights, HID lamp replacements of all types and forms, etc., combinations of these, etc.) to work with the MCC prototype unit.

Existing sensors including daylight harvesting sensors, other photo/light sensors, motion/occupancy sensors, other environment/ambient sensors, etc. can be used with the present invention. The circadian rhythm regulation system can prompt, notify, alert the user if an inappropriate light source such as, for example, a smart phone/tablet or television set is detected that is emitting inappropriate wavelengths for that part/phase of the circadian rhythm cycle. If the user does not respond to the prompts, notifications and/or alerts, the circadian rhythm regulation system will attempt to modify the offending light source to be circadian rhythm cycle phase-compliant. Such prompts can be sent to, among others and not limited to, family, friends, medical staff, hospital staff, doctors, care givers, emergency responders, etc. by any means including but not limited to cell phones, land line phones, smart phones, mobile phones, tablets, computers, answering machines, text messages, e-mails, pictures, etc., more than one of these, combinations of these, other methods, ways, etc. discussed herein, etc.

Software apps can be used to gather information including geographical location, time zone, ambient light, settings of in-use digital devices including cell/smart phones, tablets, laptop computers, desktop computer displays and monitors, (if possible) televisions, MP3 players, etc. The system uses this information to adjust the display settings to support circadian rhythm cycle alignment and circadian rhythmicity and to avoid or mitigate circadian desynchrony and circadian disruption as well as treat SAD and provide other types of light therapy.

Embodiments of the present invention can include low-cost portable battery-powered/solar powered optical color ‘notch’ filters so as to be able employ these color filters as and where needed to provide additional optical sensory information and feedback to the MCC unit to aid in circadian rhythm regulation.

Some embodiments of the present invention thus provide a means to improve circadian rhythm. SAD, and other illnesses, diseases, disorders, etc. discussed herein by, for example, but not limited to, providing the appropriate wavelengths of light at appropriate times, based on data from sensors and/or information gathered from various sources and control interfaces, including but not limited to:
Internal and external photosensors including wavelength specific or the ability to gather entire or partial spectrums
Atomic clock(s) signals
Other broadcast time signals
Cellular phone times
Smart phone, tablet, computers, personal digital assistants, etc.
Remote control via dedicated units, smart phones, computers, laptops, tablets, etc.

FIGS. 1 through 47 can be used in general for all types of light therapy including but not limited to circadian rhythm light therapy, SAD light therapy, and other types of light therapy to assist with, treat, improve, etc., illnesses, diseases, cancers, disorders and general well-being.

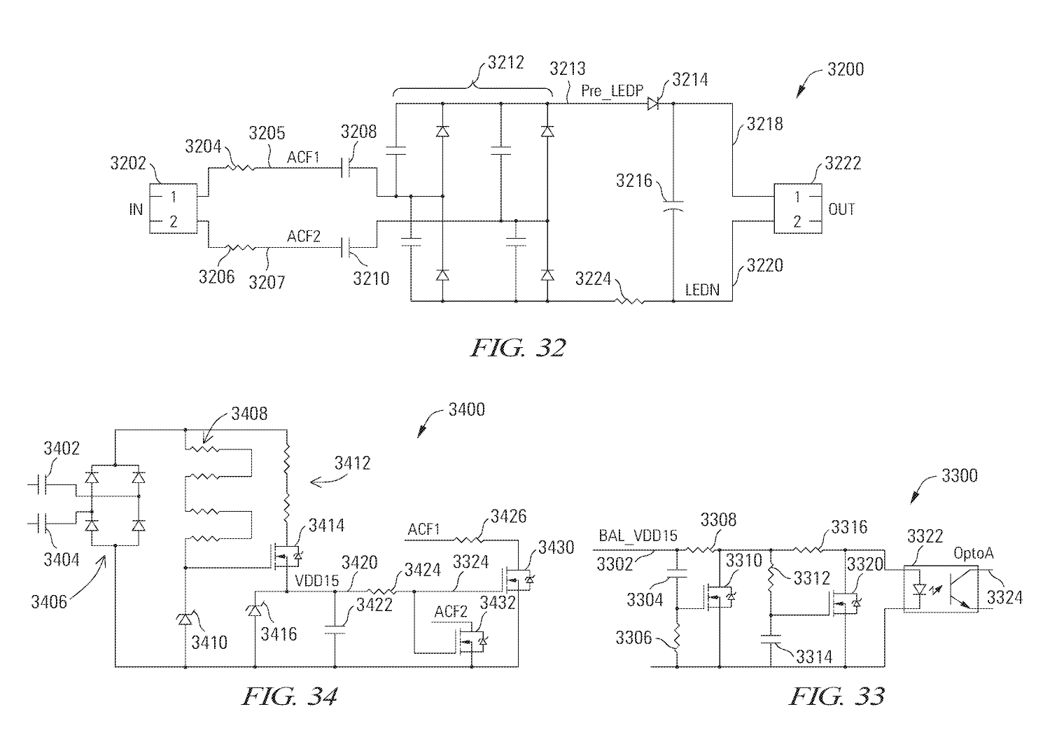

Turning now to FIG. 32, a schematic of an example power connection circuit 3200 for a solid state fluorescent replacement is depicted in accordance with some embodiments of the invention. The circuits of FIGS. 32-36 are merely examples and are not intended to be limiting, but can use a switch including, for example, a transistor such as a field effect transistor (FET) such as a MOSFET or JFET to, for example, either turn on or turn off a circuit that operates in either ballast mode or AC line mode depending on the amplitude of the signal or with the inclusion of a time constant, the average, RMS. etc. voltage level. The circuits remove the requirement that a reference level and a comparison to the reference level are required to detect the amplitude of the waveform.

An AC input 3202 can be connected, for example, to the pins in a fluorescent light fixture, either with a ballast in place or removed/bypassed. Fuses 3204, 3206 provide protection, yielding fused AC inputs ACF1 3205, ACF2 3207, and AC coupling capacitors 3208, 3210 are provided in some embodiments at the input. A diode bridge rectifier 3212 rectifies the AC input, yielding a Pre_LEDP voltage 3213. A series diode 3214 is provided in some embodiments, yielding output voltage LEDP 3218 to output 3222. A filter capacitor 3216 can be provided across the output between output nodes LEDP 3218 and LEDN 32220. In some embodiments, a current sense resistor 3224 is provided in series with the output 3222.

Turning to FIG. 33, a schematic of a startup sequence circuit 3300 for a solid state fluorescent replacement is depicted in accordance with some embodiments of the invention. A BAL_VDD15 voltage input 3302 receives a relatively low voltage, which is not limited to any particular voltage but can be adapted as practically desired, when a ballast is in place in the fluorescent light fixture. A first transistor 3310 is connected to BAL_VDD15 3302 through resistor 3308 and is controlled by series capacitor 3304 and resistor 3306. A second transistor 3320 is connected to the output of resistor 3308 through resistor 3316 and is controlled by series resistor 3312 and capacitor 3314. Optocoupler 3322 is driven by BAL_VDD15 3302 through resistors 3308, 3316, with the voltage across optocoupler 3322 controlled by transistors 3310, 3320. The startup sequence circuit 3300 generates a pulse sufficient to allow ballasts of certain types including certain rapid start ballasts to operate correctly.

Turning to FIG. 34, a schematic of a startup power detection circuit 3400 for a solid state fluorescent replacement is depicted in accordance with some embodiments of the invention. A fused AC input ACF1 3205, ACF2 3207 is received through capacitors 3402, 3404 and rectified by diode bridge 3406. A power supply comprising resistor(s) 3408, Zener diode 3410, resistor(s) 3412, transistor 3414 and Zener diode 3416 yields a low voltage VDD15 3420, which is not limited to any particular voltage but can be adapted as desired. In some embodiments, resistor(s) 3408 and Zener diode 3410 are omitted, and transistor 3414 is omitted, with resistor(s) 3412 connected to VDD15 3420. Transistors 3430, 3432 are controlled by the VDD15 3420 through optional filter 3422, 3424, which can be pulled down by the OptoA signal 3324 from optocoupler 3322.

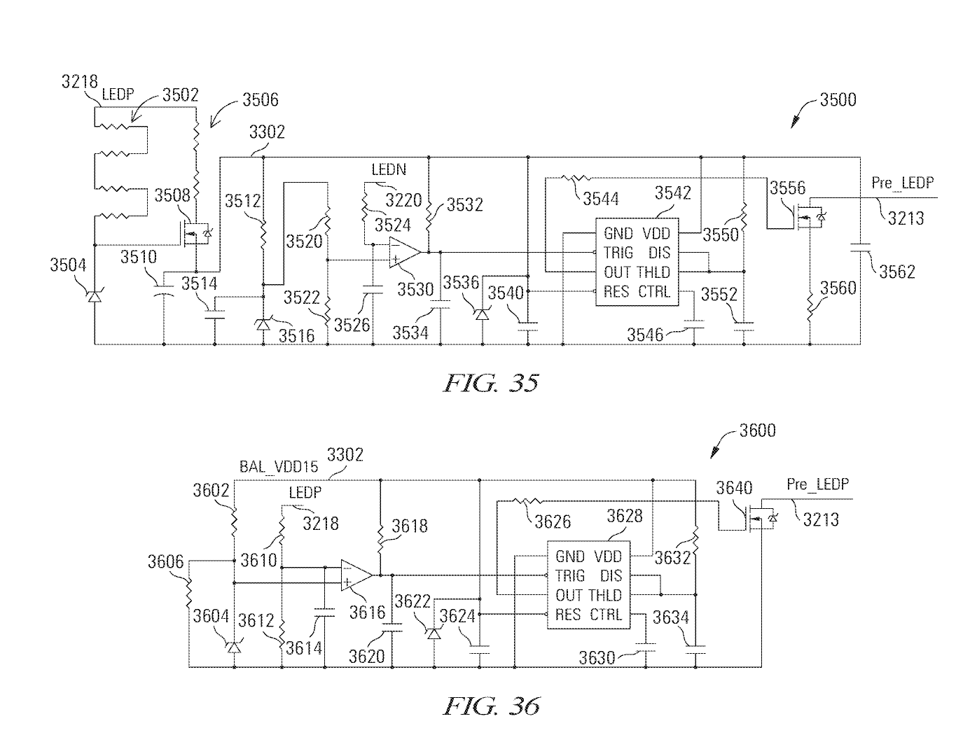

Turning to FIG. 35, a schematic of a ballast control circuit 3500 for a solid state fluorescent replacement is depicted in accordance with some embodiments of the invention. Based on the LEDP voltage 3218, a power supply comprising resistor(s) 3502, Zener diode 3504, resistor(s) 3506, transistor 3508 and capacitor 3510 yields the low voltage BAL_VDD15 3302, which is not limited to any particular voltage but can be adapted as desired, and which is used to power various internal components. Such a power supply is merely an example and is not intended to nor should be limiting in any way. In general any type of linear or switching or combination, hybrid, etc. power supply can be used. A ballast control reference voltage is generated for a comparator 3530 by capacitor 3514, resistor 3512 (which is omitted in some embodiments), Zener diode 3516, and voltage divider resistors 3520, 3522. The comparator 3530 compares this reference voltage with the LEDN signal 3220 via resistor 3524 and capacitor 3526. The output of comparator 3530 can be filtered by optional time constant based on resistor 3532, capacitor 3534, and is used to trigger a pulse generator, such as, but not limited to, a timer circuit 3542. Other components (e.g., 3544, 3546, 3550, 3552) can be included as needed and desired to support the pulse generator or timer circuit 3542. A transistor 3556, controlled by the pulse generator 3542, can be used to pull down the Pre-LEDP signal 3213. A current sense resistor 3560 can be connected in series with transistor 3556. Other components can be included as desired, such as capacitor 3562. In some embodiments, a switch such as any suitable transistor is used in place of pulse generator 3542.

Turning to FIG. 36, a schematic of a ballast overvoltage/overcurrent protection circuit 3600 for a solid state fluorescent replacement is depicted in accordance with some embodiments of the invention. A reference voltage is generated by resistor 3602. Zener diode 3604 and thermistor or temperature sensor 3606, based on the BAL_VDD15 voltage 3302. A comparator 3616 compares the reference voltage with the LEDP signal 3218 via voltage divider resistors 3610, 3612 and optional filter capacitor 3614. An optional time constant can be applied to the output of comparator 3616 by resistor 3618, 3620, and is used to trigger a pulse generator, such as, but not limited to, a timer circuit 3628. Other components (e.g., 3622, 3624, 3626, 3630, 3632, 3634) can be included as needed and desired to support the pulse generator or timer circuit 3628. A transistor 3640, controlled by the pulse generator 3628, can be used to pull down the Pre-LEDP signal 3213. In some embodiments, a switch such as any suitable transistor is used in place of pulse generator 3628.

The present invention can be used to provide the electronics for a direct fluorescent lamp replacement that uses for example LEDs or OLEDs or both or QDs or combinations of these, etc. The AC (low 50 or 60 Hz) frequency or electronic ballast (high typically ˜30 to 100 kHz) frequency can be detected using for example but not limited to a microprocessor, microcontroller, FPGA, DSP, ASIC, IC, etc. or combinations of these, etc.—such a detector (using for example a microcontroller or microprocessor, etc.) can also be used to provide the functions shown in the schematic figures of FIGS. 32-36.

As some ballasts perform various status, fault, failure, protection detection, sensing, and correction, embodiments of the present invention provide the necessary electronics, circuits including either in analog and digital (or both) implementations and associated firmware/software if needed to provide the proper sequence so that the ballast performs properly with the present direct replacement LED FLRs including rapid start ballasts. For example, the circuits depicted in FIGS. 32-36, particularly in the startup sequence circuit 3300 of FIG. 33 which generates a pulse sufficient to ballasts of certain types including certain rapid start ballasts to operate and provide power to the present invention. In addition remote operation including dimming or intensity level changes can be performed, as well as remote monitoring. Remote dimming/level changes can be accomplished for example by, for example but not limited to, inserting the output of a wireless receiver either with a built-in or separate digital to analog converter (DAC) such that the DAC is controlled by the received information from the receiver such that the output of the DAC which is connected to the input of resistor 3520 provides the programmable/controllable reference signal/voltage used to set the output current to the LEDs or OLEDs for these embodiments of the direct replacement FLR present invention. An RC circuit can be used to provide a temporary recharging voltage should the DAC (and therefore the output current) be commanded to zero. Notably, more than one DAC can be included for, for example, multi-channel uses in/with the present invention as well as analog to digital converter(s) (ADC(s)) to read various settings and operational info and report this back for example using a transceiver or transmitter, etc. In addition, 3430 and 3422 which can act as a back-to-back switch can form, with or without, resistor 3426, can form a shunt to shunt some or effectively all of the ballast current away from the SSL. A capacitor or capacitors, typically in the nanofarad (nF) range including in the low nF range can be put across the two legs of the ballast through, for example, the tombstones that carry the current to drive the SSL (e.g., LED and/or OLED) fluorescent lamp replacement to effectively reduce the maximum voltage including the open circuit voltage of the ballast. Such capacitor(s) can be a single capacitor, multiple capacitors in series or parallel, combinations, etc. Such a capacitor or capacitors can be made of a safety capacitor structure that is allowable and compatible with Underwriters Laboratory (UL) and CE allowance for use in AC line voltage applications especially as certain embodiments of the present invention allow for both/either AC line and ballast input power.

Low voltage (12 V) AC and DC lighting systems and components including MR16 can also be used for the present invention including RGBW and the use of RGBAW (i.e., R and/or A (amber) and in some cases G to produce yellow for night time, sleep time, sleep, etc. mode and BW to produce light suitable for wake up mode) as well as RGBW and the use of RGBAW with more than one white color temperature which can be in any form and could include but is not limited to a wireless or wired or powerline control (PLC) receiver, transceiver, transmitter, etc. Although a low voltage MR16 was discussed, the present invention also equally applies to all types and forms of general lighting including, but not limited to, GU10, A-lamps, E26 socket lighting, E27 socket lighting, PAR30, PAR38, R30, T12, T10, T9, T8, T5, T4, PL 2 and 4 pin, etc. and other types and forms of SSL/LED/OLED/QD lighting.

The RGBW can consist of discrete LEDs or packaged LEDs of any size and form and also could consist of additional colors and quantities such as RGBWA. RGBWB, multiple white (W) color temperatures, etc.

The present invention also includes dies of any type and form and arrangement that consist of four or more LEDs in which one of the LEDs is white—again, for example, RGBW, RGBWA (or RGBAW, etc.). The package, substrate, die, etc. that the four or more LEDs with one LED being white (e.g., RGBW) include plastic, ceramic, composite, polymers, metal, etc., combinations of these, etc. The ceramic(s) can be of any type including but not limited to oxides, nitrides, etc. such as aluminum oxide, sapphire, quartz, aluminum nitride, beryllium oxide, boron nitride, etc. Any shape can be used including essentially round, square, rectangular, elliptical, parabolic, semi-circle, semi-sphere, sphere and other standard and non-standard essentially 2 and 3 dimensional shapes and forms, etc. Two wires/pads/pins/etc. may be used per LED color or some wires/pads/pins/etc. may be reduced to reduce count, etc. for example, but not limited to, common anode or common cathode arrangements, etc.

If heat sinking is insufficient to support high power RGBW then the present invention can automatically insure that the power is either scaled back for all channels or automatically turn off, for example, the white channel or other color channels and keep the white channel on or dim one or more channels including color and/or white channel(s). In emergency or other types of situations, such heat management control may be overridden to produce additional light (i.e., higher lumens), etc.

For any of the present inventions discussed herein, power supplies of any type, form, topology, architecture. etc. including but not limited to non-isolated and/or isolated power supplies and drivers such as buck, buck-boost, boost-buck, boost. Cuk, SEPIC, forward converters, push-pull, current mode, voltage mode, current fed, voltage fed, one-stage, two-stage, multi-stage, high power factor, linear, switching, resonant converters, half bridge, full bridge, combinations of these, etc.

Embodiments of the present invention include multi-panel configurations including parallel (i.e., same voltage, shared total current through each panel) and series (i.e., same current, stacked voltage). Currently most OLED panels, whether single or multi-color, operate at a total voltage of less than 10 VDC and are typically connected in parallel. White-changing OLED panels also provide a certain subset of color changing/tunability. The circadian rhythm lighting and/or SAD and/or light therapy products can use the white-changing/tunable OLED panels to provide blue wavelength enhanced lighting for the ‘wakeup’ and blue wavelength depressed lighting for the ‘sleep-time’ for example, by using layered blue OLEDs and yellow (or amber or orange or similar wavelength color) OLEDs, respectively in any method including layered on top of each other or side-by-side stripes/strips, etc. These respective OLEDs can be color-tuned/turned on, for example, by providing an appropriate current (or in some cases, voltage) to certain electrodes turn on and excite the proper and desired color or colors depending on the particular point and phase in the circadian rhythm cycle. Implementations of the present invention for both fixed and portable circadian rhythm applications include, but are not limited to, main lighting, under-cabinet and over cabinet lighting for bedrooms, reading rooms, living rooms, dens, family rooms, offices, barracks, hotels, hotel rooms, motel rooms, bed and breakfasts, office buildings, kitchens, bathrooms, etc., desk, table, task, reading, and portable lamps/lights, accent lamp/lights and special environment lighting and other discussed herein, etc. Some embodiments of the present invention apply multiple floating output current control to driving the respective OLEDs/LEDs/QDs/other forms of SSL, etc., combinations of these, etc.

LEDs, OLEDs. QDs, light sources and panels that are color changing, blue enhanced and blue depressed (for example, but not limited to, orange, amber, yellow, reddish, red, etc.), white changing and special purpose OLEDs can be used for circadian rhythm cycle regulation and assistance and/or SAD and/or other lighting described herein as well as for medical, cleanroom, classroom, nursery, prenatal care, urgent care, long term care, critical care, intensive care, architecture design, etc. and, general lighting, etc.

The present invention applies to OLEDs, LEDs, QDs, other types of SSLs, combinations of these, etc. in general including white and other fixed color, white-changing, color-changing and multi-color, multi-panel applications including OLEDs of any type including but not limited to stacked, layered, multi-electrode, striped, patterned, etc., OLEDs and edge emitter, edge lit, and waveguided LEDs, QDs, etc.

All of the above can be wirelessly interfaced, controlled and monitored using, for example, smart phones (i.e., iPhones, Androids), tablets (i.e., iPad, iPod touch, droid, etc.), laptops, desktops and other such digital assistants and also other dimming including 0-10 Volt dimming and powerline (PLC) dimming/control. The universal drivers can also support Triac and other forward/reverse phase cut dimming.

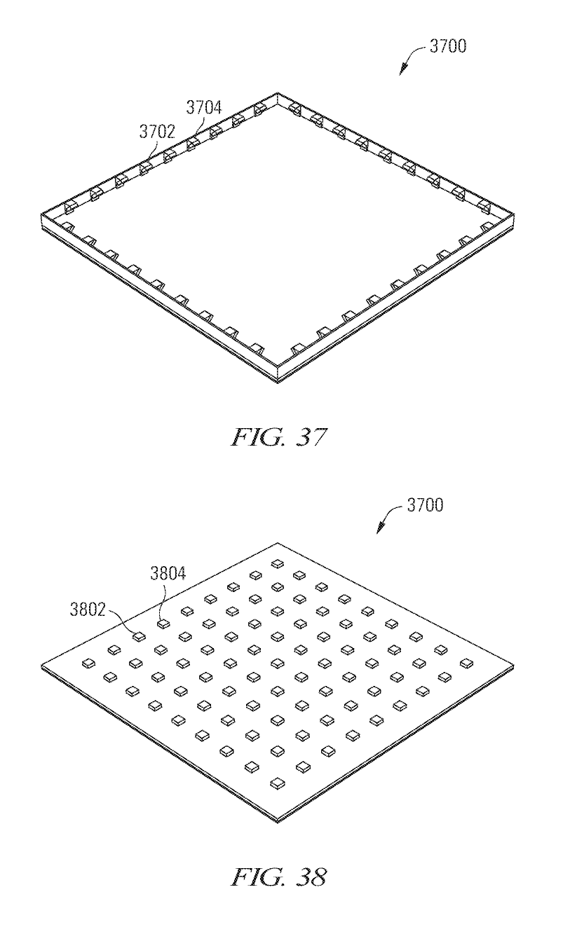

Turning now to FIGS. 37-39, in some embodiments a quasi-uniform lighting panel is provided using an array of solid state point light sources such as LED's, QD's, etc., thereby simulating a lighting panel such as an OLED. The back side of an OLED equivalent array lighting panel 3700 is depicted in FIG. 37 in accordance with some embodiments of the invention. Electrical connections (e.g., 3702, 3704) can be provided around edges of the panel or in any other suitable manner, providing power and control/addressing of individual point light sources or groups of point light sources. For example, LEDs of different color groups can be controlled as groups in some embodiments. The front side of the OLED equivalent array lighting panel 3700 is depicted in FIG. 38 in accordance with some embodiments of the invention, showing an array of point light sources such as, but not limited to, LEDs 3802, 3804, QDs, etc. The light sources can be positioned in a rectilinear array as in FIG. 38 or in any suitable pattern, and can have any number of colors, RGBW, RGBWA (or RGBAW), with one or more white (W) color temperatures, etc.

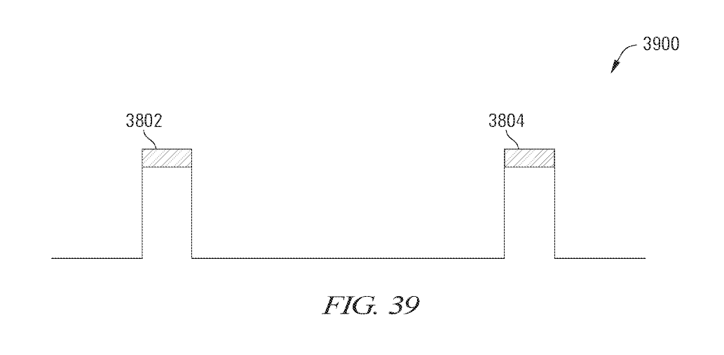

Turning to FIG. 39, a cross-sectional side view 3900 depicts several LEDs 3802, 3804 in one or more arrays of LEDs in an OLED equivalent array lighting panel in accordance with some embodiments of the invention. LEDs (e.g., 3802, 3804) can be mounted so that they are facing down onto a reflective surface, thereby producing a no-glare OLED equivalent. One or more LEDs may be positioned in each location. In some embodiments of the present invention, more than one color LED may be used. Embodiments of the present invention can provide one or more colors including, but not limited to, two colors such as blue and amber/yellow, multi-colors. RGB, 3 colors, more than 3 colors, monochrome, white, RGBA (where A is amber), RGBW (where W is white). RGBWA, RGBWA plus additional colors, etc. The LEDs can be wired in series and/or parallel and/or combinations of these. The LEDs can be at the corners, along the sides, through inserts into the reflective surface, etc.

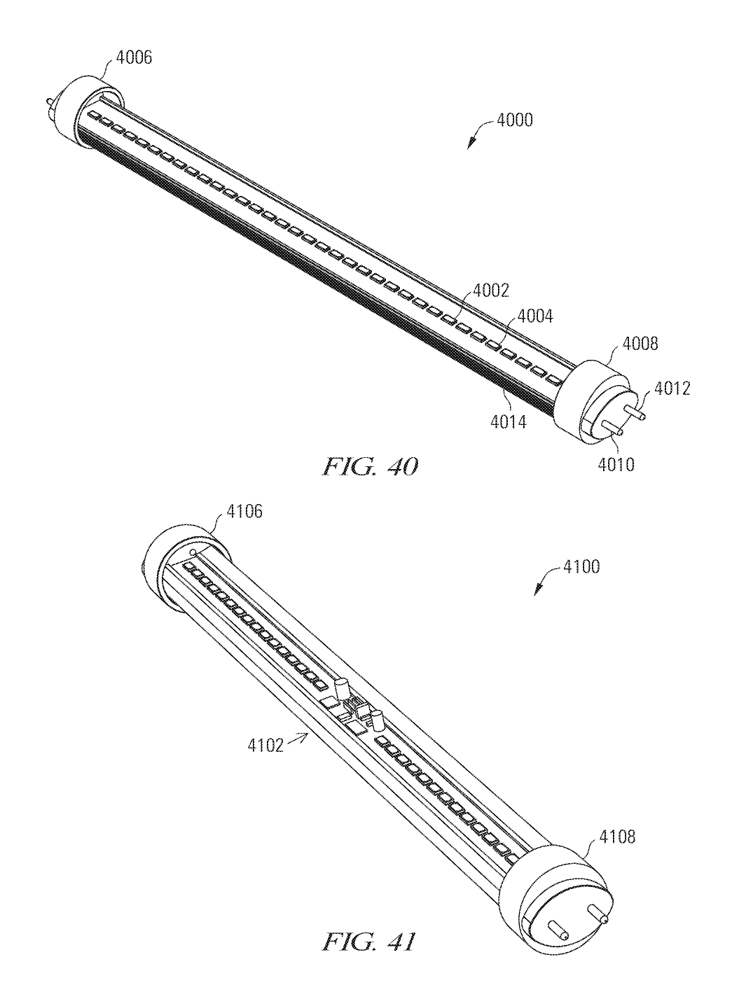

As depicted in FIGS. 40-46, in some embodiments the solid state lighting is embodied in fluorescent tube replacements, such as, but not limited to, T4, T5, T8, T9, T10, T12, PL 4 pin and 2 pin etc. An example embodiment is depicted in the FLR 4000 of FIG. 40, in which a single strip of LEDs (e.g., 4002, 4004) is mounted on a printed circuit board between end caps 4006, 4008. One or more mounting/connection pins (e.g., 4010, 4012) are provided at each end. A lens/cover/reflector etc. 4014 can be provided over one or both sides of the FLR 4000.

Turning to FIG. 41, in some embodiments, circuits 4102 can be provided on the printed circuit board, such as, but not limited to, power supply circuits, driver circuits, control circuits, monitoring circuits, reporting circuits, interface circuits, etc. In some embodiments, circuits 4102 can include sensors such as, but not limited to, temperature sensors/thermostats, cameras, thermal imaging arrays, etc. Such circuits, for example but not limited to, can be located inline with LEDs as shown in FIG. 41, or along side the LEDs to avoid interrupting the array of LEDs, in end caps 4106, 4108, or at any other location.

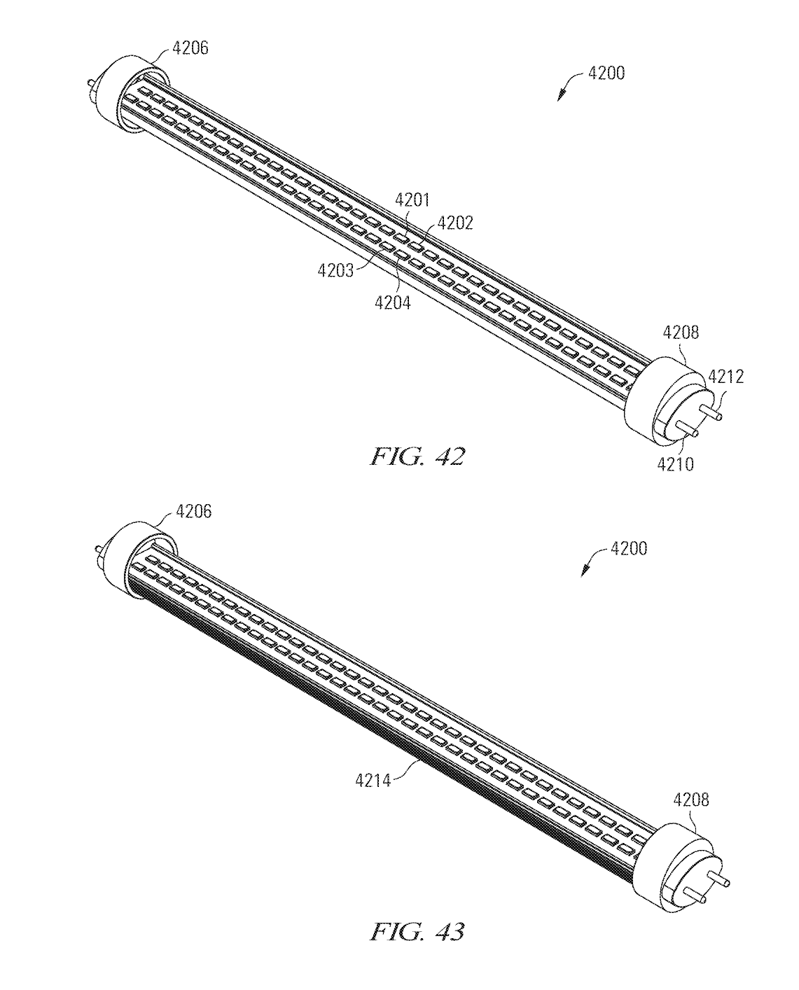

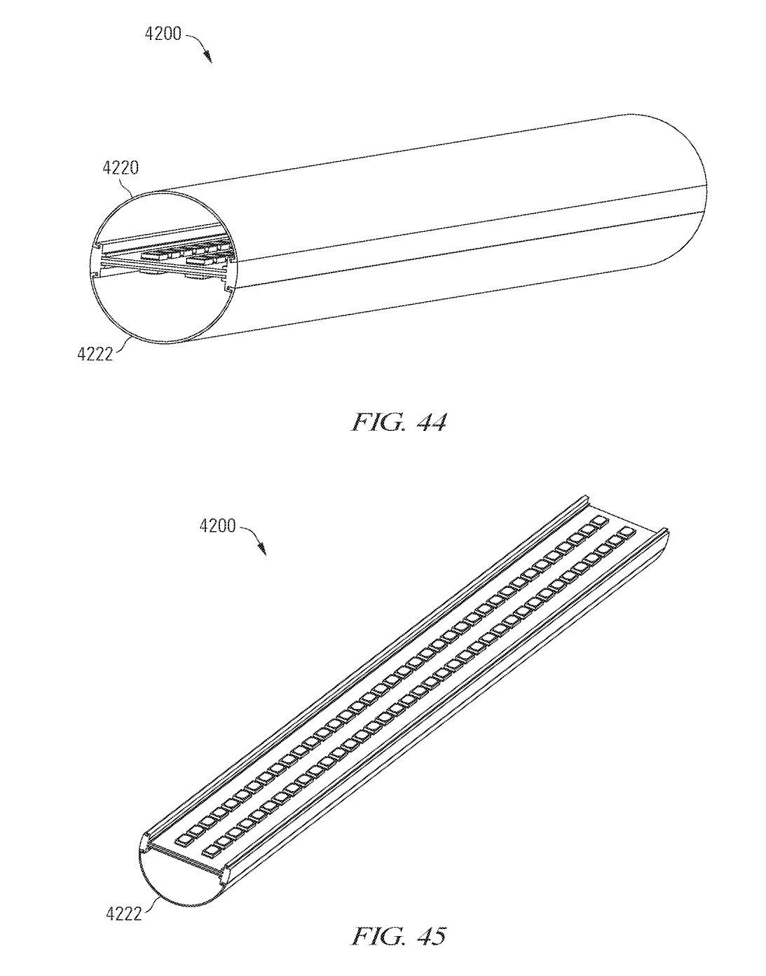

Turning to FIG. 42, in some other embodiments, a SSL FLR 4200 includes a double strip of LEDs (e.g., 4201, 4202, 4203, 4204) mounted on a printed circuit board between end caps 4206, 4208. One or more mounting/connection pins (e.g., 4210, 4212) are provided at each end. As shown in FIG. 43, a lens/cover/reflector etc. 4214 can be provided over one or both sides of the FLR 4200. As shown in FIGS. 44-45, the printed circuit board can be mounted across the widest section of the cylindrical housing, with top and/or bottom covers/lenses/diffusers/reflectors 4220, 4222 as desired. In other embodiments, the printed circuit board can be mounted nearer the top or bottom of the cylinder, as desired. More than two (double) arrays of LEDs can be used for implementations of the present invention. As shown in FIG. 44, LEDs can be mounted on both sides of the PCB, enabling for example both direct and reflected lighting, lighting of different colors/wavelengths/illumination levels, characteristics, etc. For example, both task and mood lighting can be supported, etc. More than two separate arrays of lights may be used with each array or even sub array controlled and monitored as part of the present invention to provide safe and secure operation and light output that is designed and implemented to balance power consumption and energy savings with heat load and other thermal considerations to deliver energy efficient, tunable, adjustable lighting for health, entertainment, safety, emergency, security, protection, prevention including prevention or treatment of diseases, disorders, inflictions, injuries, SAD, wellness, detection, monitoring, reporting, analytics, community well being, surveillance, monitoring, data transfer, tracking including tracking and counting by wireless devices including unique wireless devices such as cellular phones, tablets and other communications and mobile devices equipped with Bluetooth, WiFi, mobile cellular protocols and systems, including but not limited to 3G and/or 4G, broadband, satellite, etc., combinations of these as well as others discussed herein and other applications and light therapies and therapeutic methods, approaches, etc., combinations of these, etc.

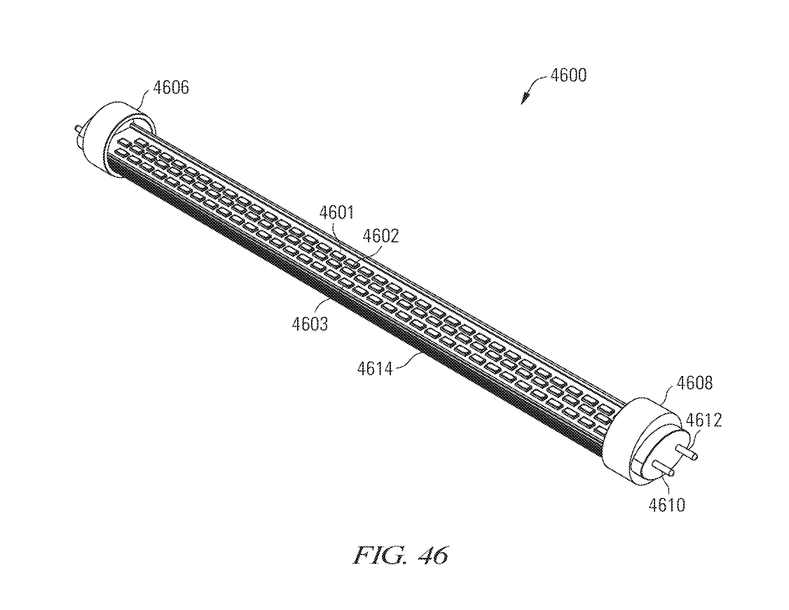

Turning to FIG. 46, in some other embodiments, a SSL FLR 4600 includes a triple strip of LEDs (e.g., 4601, 4602, 4603) mounted on a printed circuit board between end caps 4606, 4608. One or more mounting/connection pins (e.g., 4610, 4612) are provided at each end. A lens/cover/reflector etc. 4614 can be provided over one or both sides of the FLR 4600. Again, the SSL FLR 4600 can include LEDs of one or more colors including, but not limited to, two colors such as blue and amber/yellow, multi-colors. RGB, 3 colors, more than 3 colors, monochrome, white, RGBA (where A is amber), RGBW (where W is white). RGBWA. RGBWA plus additional colors, etc. Differently colored LEDs can be arranged in any desired layout/arrangement/pattern.

With a ballast, some implementations of the present invention utilize current output control with a shunt regulator with, for example but not limited to, switching mode regulation. In this case, the regulator switches to effective/local ground (low voltage drop equals low power dissipation) or open (no current equals low power dissipation). In addition to the passive and active components mentioned previously, other protection and detection devices and components can be used with the present invention including but not limited to tranzorbs, transient voltage suppressors (TVSs), Varistors, metal oxide varistors (MOVs), surge absorbers, surge arrestors, and other transients detection and protection devices, thermistors or other thermal devices, fuses, resettable fuses, circuit breakers, solid-state circuit breakers and relays, other types of relays including mechanical relays and circuit breakers, etc.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention.

Programmable soft start including being able to also have a soft short at turn-on which then allows the input voltage to rise to its running and operational level can also be included in various implementations and embodiments of the present invention.

Some embodiments of the present invention utilize high frequency diodes including high frequency diode bridges and/or synchronous transistor rectifier bridges and current to voltage conversion to transform the ballast output into a suitable form so as to be able to work with existing AC line input PFC-LED circuits and drivers. Some other embodiments of the present invention utilize high-frequency diodes and/or synchronous transistor rectifier bridges to transform the AC output of the electronic ballast (or the low frequency AC output of a magnetic ballast into a direct current (DC) format that can be used directly or with further current or voltage regulation to power and driver LEDs for a fluorescent lamp replacement. In some embodiments of the present invention, snubber and/or clamp circuits may be used with the rectification stages (which, for example, could be diodes or transistors operating in a synchronous mode); such snubbers could typically include capacitors, resistors and/or diodes or be of a lossless type of snubber where the energy is recycled or be made of capacitors only or resistors only, etc. Such snubbers can be of benefit in reducing radiated emissions. Some embodiments of the present invention can use lossless snubbers. Embodiments of the present invention can be used to convert the low frequency (i.e., typically 50 or 60 Hz) AC line and/or magnetic ballast AC as well as electronic higher frequency AC output to an appropriate current or voltage to drive and power LEDs using either or both shunt or series regulation. Some other embodiments of the present invention combine one or more of these. In some embodiments of the present invention, one or more switches can be used to clamp the output compliance current and/or voltage of the ballast. Various implementations of the present invention can involve voltage or current forward converters and/or inverters, square-wave, sine-wave, resonant-wave, etc. that include, but are not limited to, push pull, half-bridge, full-bridge, square wave, sine wave, fly-back, resonant, synchronous, linear regulation, buck, buck-boost, boost buck, boost, etc.

For the present invention, in general, any type of transistor or vacuum tube or other similarly functioning device can be used including, but not limited to, MOSFETs, JFETs, GANFETs, depletion or enhancement FETs, N and/or P FETs, CMOS, NPN and/or PNP BJTs including Darlington transistors, triodes, etc. which can be made of any suitable material and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

The example figure and embodiments shown are merely intended to provide some illustrations of the present inventions and not limiting in any way or form for the present inventions.

Using digital and/or analog designs and/or microcontrollers and/or microprocessors any and all practical combinations of control, sequencing, levels, etc., some examples of which are listed below for the present invention, can be realized.

In addition to these examples, a potentiometer or similar device such as a variable resistor may be used to control the dimming level. Such a potentiometer may be connected across a voltage such that the wiper of the potentiometer can swing from minimum voltage (i.e., full dimming) to maximum voltage (i.e., full light). Often the minimum voltage will be zero volts which may correspond to full off and, for the example embodiments shown here, the maximum will be equal to or approximately equal to the voltage on the negative input of the comparator. In addition wireless control including dimming may be used to, for example, set the reference current setpoint used, for example, to control the current supplied to the LEDs or OLEDs or QDs, etc.

Current sense methods including resistors, current transformers, current coils and windings, etc. can be used to measure and monitor the current of the present invention and provide both monitoring and protection.

In addition to dimming by adjusting, for example, a potentiometer, the present invention can also support all standards, ways, methods, approaches, techniques, etc. for interfacing, interacting with and supporting, for example, 0 to 10 V dimming by, for example, using a suitable reference voltage that can be remotely set or set via an analog or digital input such as illustrated in patent application 61/652,033 filed on May 25, 2012, for a “Dimmable LED Driver”, which is incorporated herein by reference for all purposes.

The present invention supports all standards and conventions for 0 to 10 V dimming or other dimming techniques. In addition the present invention can support, for example, overcurrent, overvoltage, short circuit, and over-temperature protection. The present invention can also measure and monitor electrical parameters including, but not limited to, input current, input voltage, power factor, apparent power, real power, inrush current, harmonic distortion, total harmonic distortion, power consumed, watthours (WH) or killowatt hours (kWH), etc. of the load or loads connected to the present invention. In addition, in certain configurations and embodiments, some or all of the output electrical parameters may also be monitored and/or controlled directly for, for example, LED drivers and FL ballasts. Such output parameters can include, but are not limited to, output current, output voltage, output power, duty cycle, PWM, dimming level(s), etc.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

The above examples and figures are merely meant to provide illustrations of the present and should not be construed as limiting in any way or form for the present invention.

In addition to the examples above and any combinations of the above examples, the present invention can have multiple dimming levels set by the dimmer in conjunction with the motion sensor and photosensor/photodetector and/or other control and monitoring inputs including, but not limited to, analog (e.g., 0 to 10 V, 0 to 3 V, etc.), digital (RS232, RS485, USB, DMX, SPI, SPC, UART, other serial interfaces, etc.), a combination of analog and digital, analog-to-digital converters and interfaces, digital-to-analog converters and interfaces, wired, wireless (i.e., RF, WiFi, ZigBee, Zwave, Bluetooth, Bluetooth low energy, ISM bands, 2.4 GHz, IEEE 802, WeMo, Wink, etc.), powerline (PLC) including but not limited to X-10, Insteon, HomePlug, etc.), etc.

The present invention is highly configurable and words such as current, set, specified, etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc. Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, touch sensor(s), wired, wireless, PLC interfaces, etc. In addition, both control and monitoring of some or all aspects of the dimming, motion sensing, light detection level, sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, linear regulators, etc. The present invention works with both isolated and non-isolated designs including, but not limited to, buck, boost-buck, buck-boost, boost, cuk, SEPIC, flyback and forward-converters. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic. etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may be used in conjunction with dimming to provide thermal control or other types of control to, for example, a dimming LED driver. For example, embodiments of the present invention may also be adapted to provide overvoltage or overcurrent protection, short circuit protection for, for example, a dimming LED or OLED or QD driver, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless, powerline, etc. and can be implemented in any part of the circuit for the present invention. The present invention can be used with a buck, a buck-boost, a boost-buck and/or a boost, flyback, or forward-converter design, topology, implementation, etc.

A dimming voltage signal. VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention includes embodiments that have autonomous motion and light/photodetection control, and can and may also use other types of stimuli, input, detection, feedback, response, etc. including but not limited to sound, voice, voice control, motion, gesturing, vibration, frequencies above and below the typical human hearing range, temperature, humidity, pressure, light including below the visible (i.e., infrared, IR) and above the visible (i.e., ultraviolet, UV), radio frequency signals, combinations of these, etc.

For example, the motion sensor may be replaced or augmented with a sound sensor (including broad, narrow, notch, tuned, tank, etc. frequency response sound sensors), a voice sensor and/or detector, voice recognition, and the light sensor could consist of one or more of the following: visible, IR. UV, etc., sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both including, but not limited to, Darlington transistors, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some cases, parts of a given system, block or circuit may be implemented in software or firmware, while other parts are implemented in hardware.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A lighting system comprising:
at least one solid state light source having a controllable color output;
a power supply configured to power the at least one solid state light source; and
a controller configured to control the power supply to adjust the color output of the at least one solid state light source and to dim the at least one solid state light source based at least in part on circadian rhythm information.

2. The lighting system of claim 1, further comprising a wearable circadian rhythm monitor.

3. The lighting system of claim 1, further comprising a wireless interface configured to receive control commands for the controller.

4. The lighting system of claim 3, wherein the controller is configured to monitor an electrical connection to the at least one solid state light source and to transmit resulting information via the wireless interface.

5. The lighting system of claim 4, wherein the controller is configured to gather historical electrical usage data.

6. The lighting system of claim 1, wherein the at least one solid state light source comprises a fluorescent replacement.

7. The lighting system of claim 6, wherein the power supply is configured to draw power from a fluorescent light fixture and to adapt to a presence or absence of a ballast in the fluorescent light fixture.

8. The lighting system of claim 7, further comprising at least one sensor powered by the power supply by the power drawn from the fluorescent light fixture.

9. The lighting system of claim 8, wherein the at least one sensor comprises a motion sensor.

10. The lighting system of claim 7, further comprising at least one camera powered by the power supply by the power drawn from the fluorescent light fixture.

11. The lighting system of claim 7, further comprising a thermal imaging array powered by the power supply by the power drawn from the fluorescent light fixture.

12. The lighting system of claim 1, wherein the at least one solid state light source comprises at least one light emitting panel.

13. The lighting system of claim 12, wherein the at least one light emitting panel comprises at least one OLED panel.

14. The lighting system of claim 12, wherein the at least one light emitting panel comprises a plurality of point light sources.

15. The lighting system of claim 12, wherein the at least one light emitting panel comprises a plurality of panels movably mounted on a motorized mount.

16. The lighting system of claim 15, wherein the at least one light emitting panel comprises an automatically adjustable chandelier.

17. The lighting system of claim 1, wherein the controller is configured to cause the at least one solid state light source to output a shorter wavelength light to stimulate a user and to output a longer wavelength light to promote a rest state in a user.

18. The lighting system of claim 17, wherein the controller is configured to control a wavelength from the at least one solid state light source based at least in part on time.

19. The lighting system of claim 17, wherein the controller is configured to control a wavelength from the at least one solid state light source based at least in part on location.

20. The lighting system of claim 1, wherein the at least one solid state light source is portable.
